(19) United States
(12) Patent Application Publication
(10) Pub. No.: US 2026/0220115 A1
(43) Pub. Date: Jul. 30, 2026

(54) CONTEXT-BASED INDEXED LEDGERS AND LAYERS, SYSTEMS AND METHOD

(71) Applicant: Nant Holdings IP, LLC, Culver City, CA (US)

(72) Inventors: Nicholas J. Witchey, Laguna Hills, CA (US); John Wiacek, Los Angeles, CA (US); Jake Fyfe, Walnut, CA (US); Patrick Soon-Shiong, Los Angeles, CA (US)

(21) Appl. No.: 19/457,407

(22) Filed: Jan. 23, 2026

Related U.S. Application Data
(63) Continuation-in-part of application No. 19/393,230, filed on Nov. 18, 2025.
Application No. 19/393,230 is a continuation of application No. 19/263,456, filed on Jul. 8, 2025, now Pat. No. 12,505,083.
Application No. 19/263,456 is a continuation of application No. 19/041,521, filed on Jan. 30, 2025, now Pat. No. 12,393,564.

(51) Int. Cl. G06F 16/22; G06F 16/23

(52) U.S. Cl. CPC G06F 16/2255; G06F 16/2379

(57) ABSTRACT

Techniques for obtaining digital transaction data including transaction context information associated with a real-world asset or virtual asset. The techniques further including generating a transaction context index as a function of the transaction context information. The techniques further include accessing an indexed notarized ledger stored in the at least one memory from the plurality of notarized ledgers where the context index corresponding to the indexed notarized ledger satisfies a query based at least in part on the transaction context index. The techniques further include instantiating a transaction record memorializing the digital transaction data with respect to the asset or context. The techniques further include instantiating a ledger transaction adhering to a format of the indexed notarized ledger based at least in part on the transaction record. The techniques further include recording the ledger transaction representing the transaction record on the indexed notarized ledger in the at least one memory.

### CROSS REFERENCE TO RELATED APPLICATIONS

This application is a continuation-in-part of U.S. Non-Provisional Application No. Ser. No. 19/393,230 filed Nov. 18, 2025 titled “Location Indexed Blockchains, Systems And Method,” which is a continuation of U.S. Non-Provisional Application No. Ser. No. 19/263,456, filed Jul. 8, 2025 titled “Location Indexed Blockchains, Systems And Method,” which is a continuation of U.S. Non-Provisional Application No. Ser. No. 19/041,521, filed Jan. 30, 2025 titled “Location Indexed Blockchains, Systems And Method,” the contents of which are herein incorporated by reference in their entirety for all purposes.

### FIELD OF THE INVENTION

The field of the invention generally relates to managing digital notarized ledgers (e.g., blockchains, distributed ledger, etc.), possibly using a hierarchy of ledgers, organized or indexed by context information.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

All publications and patent applications herein are incorporated by reference in their entirety and for all purposes. All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

By way of introduction, a blockchain represents blocks or chunks of data that are linked together via cryptography technology. Each block includes, among other things, data and a cryptographic hash of at least a previous block. The cryptographic hash serves as a link to the previous block. As such, the blocks form a chain of blocks (e.g., a blockchain) linked via cryptographic hashes. The data in each block is secured (e.g., against unauthorized modifications, etc.) because any change would cause an alteration in all subsequent blocks thereby indicating a modification took place. Generally, a distributed computing architecture is used to manage the blockchain. This architecture can involve multiple computer nodes. Each computer node can store blocks of the blockchain, and the computer nodes implement one or more protocols to communicate and validate blocks.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be understood that many of the foundational technical features provided in the following specification are presented to enable compact examination of the disclosed inventive subject matter. While some of the foundational technical features described herein may seem obscure, in many cases such features may be considered within the scope of understanding of one skilled in the art. Thus, presentation of such background technologies should not be considered limiting.

### SUMMARY

The inventive subject matter provides apparatuses, systems, and methods in which ledgers may include a hierarchy of relationships with other ledgers. Further inventive subject matter relates to blockchains or other notarized ledgers indexed by location or context. A location may include a place (e.g., physical building or virtual building, file path, a network address, location in memory, etc.), an area (e.g., a one acre property, a state, etc.), a setting (e.g., a restaurant, a corporate office, etc.), a position (e.g., latitude 33.9235074, longitude −118.3867642; a plus code, S2 cell identifier, Geohash identifier, etc.), or other type of places that can have a corresponding coordinate.

One should appreciate the disclosed inventive subject matter is presented from the perspective of location-bound ledgers, while other types of indexing are also contemplated as discussed further below. Physical locations, especially historic locations, may include plaques that describe events that took place at the location. In recent times, augmented reality or mobile technologies provide access to additional information about possible location information based on use of bar codes, AR content bound to a location, or other methods. However, such location information is not necessarily authoritative or authentic. Rather, the information is merely created as content and provided to user devices. Embodiments of the inventive subject matter disclosed herein improve on location-based services and other related services by providing access to immutable data related to a location or through location-based interactions, possibly based on device context, with notarized ledgers and/or corresponding digital tokens.

In an embodiment, at least one ledger is bound or otherwise linked to a context, possibly including a location. The ledger may record transactions (e.g., representing events, sales, rentals, a merchant inventory, a player, a player inventory, exchanges, events, alternative trading system transactions, etc.) related to the location. Further, the ledger may be indexable by a context, the location for example, and the index may be determined using the location or derived from the location. In an embodiment, a computer-based data indexing system includes at least one non-transitory computer readable memory storing a plurality of notarized ledgers or storing pointers to the plurality of notarized ledgers where each notarized ledger or pointer is indexed in the memory by at least one corresponding context, a geographic location index for example, and also storing software instructions, and at least one processor coupled with the at least one memory, which upon execution of the software instructions, performs operations. The operations may include obtaining digital transaction data including digital transaction context information associated with a real-world device. The operations may further include generating or deriving a transaction context index as a function of the digital transaction context information. The operations may further include accessing, directly or indirectly via a pointer, an indexed notarized ledger stored in the at least one memory from the plurality of notarized ledgers where the context index corresponding to of the indexed notarized ledger satisfies a query based on the transaction context index. The operations may further include instantiating in the at least one memory a transaction record memorializing the digital transaction data with respect to the real-world device. The operations may further include instantiating a ledger transaction adhering to a format of the indexed notarized ledger based on the transaction record. The operations may further include recording or memorializing the ledger transaction representing the transaction record on the indexed notarized ledger in the at least one memory.

Embodiments allow information to be memorialized using a ledger (e.g., a private notarized ledger, a public notarized ledger, a distributed ledger, graph-based ledger, etc.) such that the information, and possibly the origin of the information, can be immutable so that devices can trust the information. Additionally, devices would be able to consult the ledger to see how the information has changed with time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates a block diagram of a system according to certain embodiments, in accordance with the present disclosure.

FIG. 2 illustrates a block diagram of a blockchain block according to certain embodiments, in accordance with the present disclosure.

FIG. 3 illustrates a block diagram of a parent ledger and a child ledger according to certain embodiments, in accordance with the present disclosure.

FIG. 4 illustrates a block diagram of a non-fungible token (NFT) according to according to certain embodiments, in accordance with the present disclosure.

FIG. 5 shows a flow diagram illustrating a method utilized by a transaction management system according to certain embodiments, in accordance with the present disclosure.

FIG. 6 shows a flow diagram illustrating a method utilized by a computer-based data indexing system according to certain embodiments, in accordance with the present disclosure.

FIG. 7 illustrates a block diagram of a system for viewing blockchain data according to certain embodiments, in accordance with the present disclosure.

FIG. 8 is a block diagram of a distributed computer system usable to implement embodiments of the present disclosure.

FIG. 9 illustrates an N-dimensional context space.

FIG. 10 illustrates a space filling curve for high dimensional spaces.

FIG. 11 provides an overview of a context-based indexing system for a ledger-based application stack.

### DEFINITIONS

A “blockchain” or “ledger” can be a distributed/decentralized data structure that maintains a continuously growing list of records secured from tampering and revision. A blockchain or other type of notarized ledger can be an NFT blockchain, a cryptocurrency blockchain, a hash graph, a directed acyclic graph, a holochain, a linked list, or a combination thereof. A blockchain may include a number of blocks, each block including one or more of interaction or transaction records. Each block in the blockchain can include a timestamp and a link to a previous block where the nature of the block depends on the previously, possibly through a hash. Stated differently, interaction records in a blockchain may be stored as a series of “blocks,” or permanent files or records that include a record of a number of interactions occurring over a given period of time. Blocks may be appended to a blockchain by an appropriate computing node after it completes the block and the block is validated. Each block can be associated with a block header. In embodiments of the invention, a blockchain may be distributed, and a copy of the blockchain may be maintained at each full node in a verification network. Any node within the verification network may subsequently use the blockchain to verify interactions. A blockchain can be stored, maintained, and updated in a distributed manner in a peer-to-peer network. Blockchains or other types of ledgers may be public where all blocks are visible to everyone, private where the ledger is accessible to authorized users, distributed across multiple participating computing nodes, centralized possibly on private computing nodes, or have other structures. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others where the distributed ledger represents each transaction and where units of the cryptocurrency are transferred between entities.

An “NFT” is a non-fungible token type of digital token. NFTs serve as a unique digital identifier that is recorded on a blockchain and used to certify ownership and/or authenticity of a virtual asset or real-world asset. NFTs can be created or instantiated (i.e., typically called “minting”), bought, sold, auctioned, burned, or otherwise managed as digital objects. Management of NFTs can be achieved through use of corresponding smart contracts that follow token standards such as via Ethereum smart contract standards. The Ethereum smart contract ecosystem has multiple standards by which tokens may be managed including ERC-20, which represents fungible tokens; cryptocurrency coins for example. ERC-721 defines interfaces by which one may manage NFTs via smart contracts. According to ERC-721 transactions relating to an NFT (e.g., minting, transfers, burning, etc.) are recorded on the Ethereum blockchain to retain a ledger of all desired actions associated with the NFT. Further ERC-998 defines interfaces for creating tokens comprising sub-tokens and vice versa, typically referred to a composable tokens. Yet further, ERC-1155 defines interfaces by which one can create token sets. As individuals interact with Ethereum tokens via one or more transactions, the transactions are recorded on the Ethereum blockchain thereby forming an immutable ledger of the existence of such tokens. One should appreciate that Ethereum is used as an example. Each ledger may comprise its own NFT standard interfaces via which the ledger-specific NFTs may be managed. Further, the following discussion references use of NFTs; however, use of other types of ledger-based tokens may also be leveraged with the inventive subject matter. For example, a composable token (i.e., ERC-998 like token) may represent an entire ledger-based application stack where each token (e.g., NFT, ERC-1155-like, etc.) in the composable token corresponds to a layer or feature in the stack. One should appreciate that an NFT, composable token, a collection token, or other standardized tokens represent types of digital tokens that can be managed via or according to their corresponding notarized ledger protocols and/or smart contracts.

A “wallet address” uniquely identifies a ledger account bound to a ledger. Tokens can be recorded as being “stored” in the wallet of entity or person and retrieved for future use by recording transactions relating to the digital tokens on the ledger using the wallet address. A wallet can comprise more than one address of an account. Thus, a wallet could have multiple addresses associated with the corresponding ledger technology where each address could operate as a token owner identifier. Example wallet address types include P2PKH address, P2SH address, Bech32 address, portion of a 256-bit hash, GUID, UUID, custom address (e.g., 512-bit hash, an alphanumeric string, etc.), etc.

### DETAILED DESCRIPTION

The present application relates to enabling information to be memorialized on a ledger such that the information, and possibly the origin of the information, can be digitally memorialized in an immutable fashion so that devices can trust, or otherwise authenticate or validate the information as being valid. Additionally, computing devices would be able to consult the ledger to see how the information has changed or evolved with time. The ledger on which the information is memorialized may be determined based on one or more indices of the ledger in a hierarchy of ledgers or other organizational structure of ledgers. An index of the ledger may be determined based on a function, the function may depend on a location, a time, an owner of a ledger, a wallet address, game data, and/or other data derived from context device data received or otherwise obtained from the computing device. The following discussion presents the inventive subject matter from the perspective of using location information as a basis for a ledger index. However, it is contemplated that other types of information may form the basis of a ledger index. For example, time information (e.g., relative time, absolute time, time duration, periods of time, a day of the week, a month, a year, etc.) may form the basis of the ledger index. Additional considerations with regards to ledgers indices will be discussed later in this document.

It should be noted that any language directed to a computer should be read to include any suitable combination of computing devices, including servers, cloud devices, interfaces, systems, databases, agents, peers, engines, controllers, modules, or other types of computing devices operating individually or collectively. One should appreciate the computing devices comprise at least one processor (e.g., central processing unit (CPU), graphics processing unit (GPU), field programmable gate array (FPGA), tensor processing unit (TPU), programmable logic array (PLA), etc.) configured to execute software instructions stored on a tangible, non-transitory computer-readable storage medium (e.g., hard drive, FPGA, PLA, solid state drive (SSD), random access memory (RAM), video random access memory (VRAM), flash, read only memory (ROM), etc.). The software instructions or suite of software instructions configure or program the computing device or their processors to provide the roles, responsibilities, or other functionality as discussed below with respect to the disclosed apparatus or systems. Further, the disclosed technologies can be embodied as a computer program product that includes a non-transitory computer-readable medium storing the software instructions or a suite of software instructions that cause one or more processors to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, TCP, UDP, FTP, SNMP, IP, AES, public-private key exchanges, web service or RESTful APIs, known financial operation protocols, or other electronic information exchanging methods. Data exchanges among devices can be conducted over a packet-switched network, the Internet, LAN, WAN, VPN, or other type of packet switched network; a circuit switched network; cell switched network; or other type of network, wired or wireless.

As used in the description herein and throughout the claims that follow, when a system, engine, server, agent, device, module, or other computing element is described as configured to perform or execute functions on data in a memory, the meaning of “configured to” or “programmed to” is defined as one or more processors or cores of the computing element being programmed by a set of software instructions stored in the memory of the computing element to execute or perform operations of the set of functions on target digital data or digital data objects stored in the memory. It should be appreciated the combination of software and hardware working in concert create a dedicated set of physical, real-world structures that provide utility to one or more users that would not exist outside the scope of the physical, real-world assets.

Techniques are described herein that enable digital ledgers to be indexed based on device data such as a location related to the device. Certain embodiments herein describe ledgers indexed based on at least location, the index may identify a specific ledger from a set of ledgers. In the interest of clarity of explanation, a digital token such as a non-fungible token (NFT) is used as an example in embodiments of the present disclosure for various explanations and illustrated use cases. However, the embodiments are not so limited, and as such are similarly and equivalently applied to other types of digital tokens. Further, the described techniques enable a parent ledger to facilitate the management of the child ledger by way of the NFT or, similarly, the digital token.

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Examples herein are directed to among other things, systems and methods relating to indexing ledgers (e.g., in a hierarchy of ledgers, in a database of ledgers, etc.). A parent ledger may be used to manage child ledgers. Further, a transaction management system may be used to determine an index of a ledger that may then be used to identify or point to a ledger for reading and/or for writing, among other things, transaction data.

In an embodiment, at least one ledger is bound or otherwise related to a location. The ledger may record transactions (e.g., events, payments, history, interactions, exchanges, transmission, communications, etc.) related to the location. Further, the ledger may be indexable by the location and the index may be determined using the location. In an embodiment, a computer-based data indexing system includes at least one non-transitory computer readable memory storing a plurality of notarized ledgers where each notarized ledger is indexed by at least one corresponding location index (e.g., geographical location, physical location, virtual location, etc.) and storing software instructions and at least one processor coupled with the at least one memory, which upon execution of the software instructions, performs operations. The operations may include the processor obtaining digital transaction data including transaction geolocation information associated with a real-world geolocation. The operations may further include generating a transaction geolocation index derived from or as a function of the transaction geolocation information. The operations may further include accessing an indexed notarized ledger stored in the at least one memory from the plurality of notarized ledgers where the geographic location index corresponding to the indexed notarized ledger satisfies a query based on the transaction geolocation index. The operations may further include instantiating a transaction record memorializing the digital transaction data with respect to or associated with the real-world geolocation. The operations may further include instantiating a ledger transaction adhering to a format of the indexed notarized ledger based on the transaction record. The operations may further include recording the ledger transaction representing the transaction record on the indexed notarized ledger in the at least one memory.

Embodiments described herein may provide technologies where a ledger is indexed according to at least a location or other type of attribute. The techniques of managing indexed ledgers may further enable a ledger hierarchy or ledger organization to be maintained or otherwise managed. Ledgers indexed in a ledger hierarchy may enable for a ledger to be searched for and/or accessed using a ledger management system. The ledger management system may enable for a relatively fast (e.g., fast search times) and low processing operations (e.g., O(log n) logarithmic time complexity, O(1) constant time complexity, etc.) determination of an index ledger that corresponds to received data (e.g., data received from a device, data associated with an account, etc.). Ledgers indexed in a ledger hierarchy may reduce energy consumption, processing resources, networking resources, and/or memory resources (e.g., smaller memory requirements, less physical memory space being used, etc.) used by a given ledger because the ledger may include a portion of data while a different ledger (e.g., a sub-ledger, a child ledger, grandchild ledger, etc.) may include a more detailed representation of the data.

Certain embodiments may improve security and authentication compared to other systems. For example, embodiments may enhance authentication because ledgers may be accessed based on location or object identity, thereby enabling two-factor or other multi-factor authentication to occur for ledger access (e.g., in addition to consensus mechanisms, in addition to a wallet address, in addition to a token associated with a wallet address, etc.). Certain embodiments may enhance confidentiality, integrity, and/or availability of data recorded on a ledger. For example, by storing data or recording transactions in ledger hierarchies confidentiality of data may be increased as principles of least privilege may be enabled possibly via separation of information among the ledgers. In an example, indexing ledgers based on a attributes, location or other device context data may enable data integrity to be enhanced because the data may be trusted to be accurate based on the conditions that may be implemented to access (e.g., open access to, close access to, write to, read from, update, configure, control, etc.) indexed ledgers. In an example, using NFTs as tokens to grant permissions to data on other indexed ledgers may enhance permission controls related to ledgers, thereby improving data integrity of the indexed ledgers.

In certain embodiments, a location based indexed ledger can reduce energy consumption, processing resources, networking resources, and/or memory resources used by the location based indexed ledgers compared to traditional ledgers. Traditional ledgers may be distributed and used to record data regardless of a location (e.g., physical real-world location, city, etc.) where the data is related to and/or generated at. Thus, such ledgers consume computing resources and storage inefficiently because all ledger nodes are required to store a complete copy of their respective ledgers. On the other hand, certain embodiments described herein can be configured to enable a ledger to record data that is generated at the location or otherwise related to the location. Thus, rather than a traditional blockchain that grows without limit and is duplicated among myriad nodes consuming vast amounts of computer memory, location-bound or context-bound ledgers can enable more efficient use of memory thereby reducing the overall cost of management and overall need for duplicated hardware while also increasing the speed (e.g., reduce latency, etc.) by which “notarized” location-based information may be accessed.

As an example of an embodiment illustrating how a hierarchy of ledgers may be used, consider a first ledger related to a first shop in the shopping center and a second ledger related to a second shop in the same shopping center. Such ledgers may be established for the shops to track various events associated their respective shops such as foot traffic, number of transactions, security alerts, rent, inventory, and/or other shop related information. A customer may purchase goods from the first shop. The purchase may be represented by device data generated by and transmitted by a point of sale device location in the first shop. The device data may be transmitted to a transaction management system. The transaction management system may determine that the device data includes an indication that the purchase occurred in the first shop or involved a specific device identifier (e.g., a device identifier of the point of sale device, payment device, etc.). The transaction management system may use the device data to determine whether the device data, a subset of the device data, or data derived using the device data is to be recorded to the first ledger or the second ledger. In the example, the transaction management system may determine that a subset of the device data should be recorded on the first ledger because the purchase occurred in the first shop based on at least the first shop location. Thus, the first shop ledger and the second shop ledger may be distinguished from each other. The transaction management system may transmit transaction data to the first ledger for recordation. The transaction data may be generated to include the device data, a subset of the device data, and/or other context data derived from the device data. In the example, the transaction data may include a transaction amount, a customer identifier, a time that were each obtained from the device data, or other related transaction information.

In another example, a similar process may occur as described above and a subset of transaction data or different transaction data may be transmitted to a third ledger. The third ledger may include a ledger for the shopping center itself that the first shop and the second shop are located within. In certain embodiments, the third ledger may have permissions granted to the shopping center owner that are not granted to the shop owners. For example, the shopping center owner may be able to view the data on the third ledger to determine how business is going for the first shop or the second shop, or track rent, repairs, or other information for which the shopping center owner may be interested in or responsible for. The data on the third ledger may be a summary of the data included on the first ledger and/or the second ledger, which may include respective transaction data viewable by the shop owners and having further detail than the transaction data included on the third ledger. Thus, the third ledger can be considered to be at a higher level in a hierarchy of ledgers relative to the ledgers of the first and second shops. The third ledger may also include digital tokens that reference the first or the second shops. For example, a non-fungible token can be minted on the third ledger when a shop opens where the NFT comprises a pointer or address to the corresponding shop or the shops individual ledger. Thus, the NFT can be considered to represent the shop.

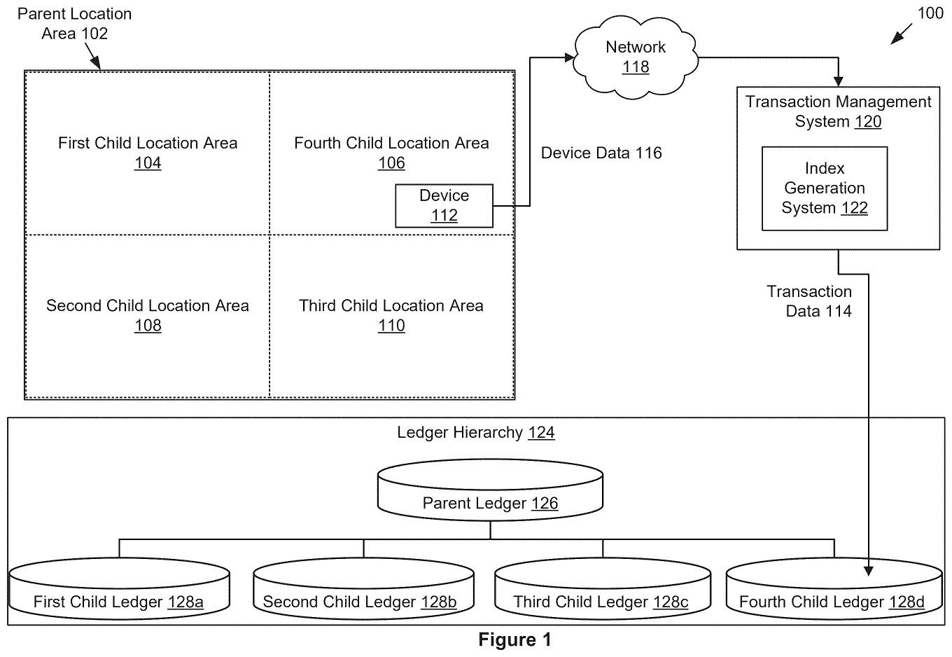

Turning now to the figures, FIG. 1 illustrates a block diagram of a computer-based system 100 according to certain embodiments, in accordance with the present disclosure. System 100 may include a device 112, a network 118, a transaction management system 120, and one or more non-transitory computer readable memories storing one or more notarized ledgers.

Device 112 may include a device such as a user device (e.g., a tablet, a phone, a laptop, game device, etc.), a smart device (e.g., a smart (e.g., internet connected) lamp, a smart thermostat, a smart car, a smart tractor, a smart solar panel, a smart battery pack, internet of things (IOT) device, AI enabled device, etc.), and/or a server. The device 112 may include zero or more user interfaces (e.g., touchscreen, keyboard, camera, etc.), zero or more sensors (e.g., accelerometer, temperature sensor, optical sensor, etc.). The device 112 may be configured to determine a location of the device 112. The location may be determined using, input received from a user interface, an optical sensor (e.g., a camera reading a barcode that corresponds to a location, a camera performing object recognition, etc.), triangulation, and/or global positioning signals (GPS) signals received from another device (e.g., a satellite, wireless triangulation, vSLAM, etc.). One of ordinary skill in the art with the benefit of the present disclosure will recognize other techniques to determine a location of the device 112. The location of device 112 provides at least one attribute, possibly of a larger context, that may be used to search for an index a notarized ledger from a plurality of ledgers.

The device 112 may generate device data 116 based at least in part on receiving input from a user interface (e.g., a keyboard, mouse, touchscreen, etc.), another device (e.g., via a network 118 connection, USB, etc.), and/or one or more sensors (e.g., a motion sensor, an optical sensor, GPS sensor, accelerometer, magnetometer, hall probe, piezoelectric sensor, microphone, camera, etc.). Device data 116 may be used to generate one or contexts related to device 112. A context may be considered a collection of attributes that collectively form the context. For example, a context of “shopping” might include attributes such as a location (e.g., a shop location, a mall location, store location, etc.), a time spent at the location, a user input indicating their current activity (e.g., a purchase, an indication of shopping, etc.), or other related information. When device data 116 satisfies the definition of or the context criteria for the context, then the context may be considered valid or otherwise active. More than one context may be active or valid at a given time. Thus, each possible context may be defined automatically, defined a priori, adhere to standard definition, or otherwise created as needed or desired and determined from device data 116.

The device data 116 may include device information (e.g., type of device 112, software version operating on the device 112, available memory space on the device 112, hardware information, battery information, model number, build number, version information, etc.), speed information, direction information, an internet protocol (IP) address (e.g., IPv4, IPv6, etc.), environmental data (e.g., sound data, temperature data, optical data, etc.), and/or network data (e.g., a latency, a bandwidth, an IP address, etc.). As alluded to above, device data 116 may be quite varied and may include user data, motion data, time data, historical data, image data, video data, audio data, and/or other types of data and/or data modalities.

The device data 116 may include digital transaction data 114. Digital transaction data 114 may include data to be recorded as a transaction on a ledger (e.g., fourth child ledger 128d, etc.). Digital transaction data 114 may include device information such as the device 112 the transaction data 114 was generated by, when the transaction data 114 was generated, and/or what caused or triggered the transaction data 114 to be generated. Digital transaction data 114 may include transaction context information, geolocation information for example associated with a real-world geolocation. The transaction geolocation information may be information generated by device 112 and/or corresponding to a location of or proximate to device 112.

With respect to an attributes such as geolocation, the transaction geolocation information may include a latitude, a longitude, an altitude, height above sea level, a depth below ground or sea level, proximity to a landmark or point of interest, a distance from a point of interest (e.g., a relative position and/or orientation, etc.), a country identifier, a state identifier, a postal code identifier, a city identifier, a building identifier, a room identifier, a stall identifier, a parking space identifier, and/or an address of a physical location, an S2 cell identifier (see URL www. s2geometry. io), or other type of location identifier or data that can be mapped to a location identifier. Such location information may be a single valued data structure (e.g., an S2 cell identifier, zip code, geohash identifier, etc.), or multi-valued data structure (e.g., latitude and longitude, a street address, what3words, etc.). The transaction geolocation information may include varying levels of specificity. For example, the transaction geolocation information may include a country, state, and/or a city. Accordingly, a location may be associated with sub-locations, possibly in a hierarchical fashion. An example of a location with a sub location may be a country (e.g., United States, Ireland, etc.) which may include multiple states (e.g., California, Iowa, etc.) sub locations. Sub location may include sub locations of their own. For example, a state may have county or city sub locations, and still further a city may have one or more zip code locations or even neighborhood locations. One should appreciate location information may have a fine level granular detail without departing from the inventive subject matter. In more preferred embodiments, S2 cell geometries offer a high fidelity solution for generating coarse grained geo-locations to fine grained geo-location identifiers. While terrestrial locations are discussed in the context of the technical discussion provided herein, one should appreciate that any location information may be used including lunar locations, Martian locations, space-based locations, locations in virtual worlds, or other non-terrestrial locations.

The digital transaction data 114 may include a timestamp and/or demographic information (e.g., demographics of a one or more users of the device 112 or a device in communication with the device 112, such as an age, a gender, etc.). The digital transaction data 114 is not necessarily required to include monetary transaction information but may include many other types of information. For example, digital transaction data 114 may include data about an event that occurred in the real world such as a battle, an accident, a fire, a flood, when the event occurred, people, assets involved in the event, trading or managing real-world assets, or other data to be memorialized on a target ledger.

The digital transaction data 114 may include gaming data in some interesting use cases. The gaming data may include at least one of: a game event (e.g., about a specific in-game events, such as a boss fight, a quest, or a special challenge, etc.), a game location (e.g., in-game coordinates or positions within the game world, etc.), a real-world location (e.g., the real-world location corresponding to a virtual world position, etc.), a game player (e.g., a player identifier, a character name, etc.), a goal, an attribute, a session identifier, a timestamp, a player action (an action taken by the player, such as a movement, an attacks, or a choice), player progress (e.g., information on levels completed, achievements unlocked, and milestones reached, etc.), in game purchases (e.g., details about virtual items or currency bought using in-game currency (e.g., gold, silver, credits, resources, etc.) and/or non-game currency (e.g., US dollars, Japanese Yen, etc.)), inventory data (e.g., information about items, equipment, and resources the player possesses, etc.), player statistics (e.g., metrics such as health, experience points, skill levels, and scores, etc.), social interactions (e.g., data on player interactions, such as chats, friend lists, and multiplayer activities, etc.), user preferences (e.g., difficulty level, control configurations, audio/visual preferences, etc.), crash reports (e.g., data on game crashes, errors, and bug reports, etc.), heat maps (e.g., visual representations of player activity and movement patterns within the game environment, etc.), time spent (e.g., duration of playtime per session, per day, cumulatively, etc.), and/or feedback and ratings (e.g., reviews, ratings, feedback on game elements, etc.).

The device data 116 may be transmitted to the transaction management system 120. The device data 116 may be transmitted to the transaction management system 120 using the network 118. One having ordinary skill in the art would recognize that data exchanges among devices can be conducted over a packet-switched network, the Internet, LAN, WAN, VPN, or other type of packet switched network; a circuit switched network; cell switched network; or other type of network, wired or wireless. That is to say, when data is sent from a device to another device (e.g., device 112 to transaction management system 120, transaction management system 120 to a ledger (e.g., a parent ledger 126, a child ledger 128, etc.), etc.), one or more other devices may necessarily be used to allow the data to travel to the destination.

The transaction management system 120 may be included in device 112, or may be remote (e.g., feet away, miles away, geographically separated, etc.) from device 112 over a network. The transaction management system 120 comprises a computer-based system that may further include a smart contract on a notarized ledger (e.g., the parent ledger, a ledger not included in the ledger hierarchy 124, etc.). Transaction management system 120 may manage transactions related to one or more of the notarized ledgers and associated tokens. Transaction management system 120 may use received device data 116 to determine a ledger and transaction data 114 to record on the ledger. Transaction management system 120 may receive device data 116 from device 112. As described above, device data 116 may include digital transaction data 114 including transaction context information that can include geolocation information associated with a real-world geolocation (virtual-world locations are also contemplated, possibly as part of a computer game). The device data 116 can be used by the transaction management system 120 to determine an index. The index may indicate a corresponding ledger to transmit transaction data 114 to (e.g., for recording, for using to lookup, etc.). The corresponding ledger may be a ledger for recording transaction data 114. The transaction data 114 may include at least a portion of the device data 116 and/or be determined using the device data 116. As a non-limiting example, device data 116 may include information related to a store front in a mall, possibly including the store address and the owner of the store. Upon leasing the store front, device data 116 may be used to record a transaction on the mall's ledger (parent ledger 126) indicating the lease has been signed where the transaction further includes a pointer (i.e., then index) to the store's ledger (say first child ledger 128a), possibly instantiated upon the lease being signed.

Transaction management system 120 may include an index generation system 122. The index generation system 122 may generate an index. The index may correspond to a ledger. The index may represent a geolocation. The index may represent a geolocation of the device 112. The index may be the geolocation itself, derived from the geolocation via one or more functions, found via a lookup table, or through use of other suitable techniques. For example, a cell phones geo-location coordinates (i.e., latitude and longitude) may be converted to single valued S2 cell identifier via an API call to an S2 cell geometry library. For higher dimensional data (see discussion further below), such context information may be converted from the higher dimensional representation to a single valued, possibly unique, identifier. Such an approach can be achieved through assigning identifiers to “cells” in the higher dimensional space via a Hilbert curve in the higher dimensions. Still further, cells, 2D cells or higher dimensional cells, may be assigned identifiers using any suitable space filling curves (e.g., Hilbert curves, Z-order curves, FASS curves, Peano curves, Morton curves, etc.).

The index may be generated using the device data 116 (e.g., context data, time data, including transaction physical geolocation information, including transaction virtual geolocation information, etc.). The index may be generated as a function of the device data 116 (e.g., using a portion of the device data 116, using all of the device data 116, using the device data 116 in combination with other data, etc.). The function may include a mapping function that accepts device data 116 or a portion thereof. The output of the function may be based at least in part on the device data 116 (e.g., a first portion of the device data 116 and/or a second portion of the device data 116, etc.), a timestamp, previously received device data 116 (e.g., from device 112 and/or another device, etc.) or other contextual portions.

In certain embodiments, the function may include a lookup function (e.g., to lookup a set of one or more values in a database and/or lookup table, etc.) wherein the input information is mapped to at least one index. In certain embodiments, the function includes a hash function. The hash function may use the device data 116 as input, possibly context identification information, and generate a hash value that is an index as output. In certain embodiments, the hash function is used to generate a hash value that is used to determine (e.g., using the hash value with a lookup table, using the hash value as input to a function, etc.) an index corresponding to the output value, possibly through a look up table. In certain embodiments, the hash value may be compared to a set of values associated with an index to determine which value associated with an index is most similar to the hash value, and the hash value is determined to indicate the index based on the closest similarity. In a similar vein, one or more descriptors derived from device data 116 may be used where the descriptors may be organized in a tree structure to facilitate a K-nearest neighbor (Knn) search able to return one or more indices based on similarity.

As an example, the device data 116 may include geolocation information which may indicate the device 112 is located in the second child location area 108 (e.g., a specific state, a defined geofence, sub-area, a shop, a zip code, etc.) and the index generation system 122 may use the device data 116 to determine an index. In some embodiments, the index may be unique with respect to the target corpus of ledgers. The index generation system 122 may output the determined index. The determined index may correspond to or otherwise point to at least one ledger (e.g., the fourth child ledger 128d, etc.). In the illustrated example, the fourth child ledger 128d may correspond to the second child location area 108. In certain embodiments, the hash function may include a Fast 64 hash function to generate a 64 bit hash value, among other types of hashes (e.g., SHA-2 hashes, SHA-3 hashes, BLAKE3, Whirlpool, etc.) with or without salt.

With respect to geolocation, an index may include at least one S2 cell identifier, a postal code, a postal code identifier, a state identifier, a country identifier, a geofence identifier, a plus code, a parking space identifier, a building identifier, an arena identifier, a park identifier, a landmark identifier or point of interest identifier, a city identifier, a room identifier, a stall identifier, or other identifier that may map to a physical real-world location. Still, it is contemplated the index may point to a virtual location, possibly in a virtual game world for example. In certain embodiments, the index may include an identifier of a device (e.g., a device associated with a transaction, etc.) and/or a user account (e.g., a user account associated with a transaction, etc.).

An index generated based on a location (e.g., a location of the device 112, a location for a transaction, a location of a receiving device (e.g., a device receiving an NFT from the device 112, a device receiving a token from the device 112, etc.), etc.) may be referred to as a transaction geolocation index, which may be a subset of a context index. The index may correspond to an index in a data structure such as a tree (e.g., a quad tree, a binary tree, a B tree, Trie, etc.) where the tree maps to physical locations, a lookup table, a hash map, etc. The index can be used with the data structure to determine a ledger included in the ledger hierarchy 124 that corresponds to the index.

The transaction management system 120 may use the index determined by the index generation system 122 to determine a ledger from among many location-indexed ledgers to record transaction data 114 on. As described above, the index may correspond (e.g., as represented by a lookup table, a tree structure, other data structure, etc.) with a ledger identifier or may include a ledger identifier. Transaction management system 120 may access (e.g., communicate with, record to, etc.) a ledger corresponding to the index (e.g., an indexed notarized ledger, etc.). One should appreciate the ledgers may also be cross indexed via other contextual information as well, possibly including time, demographics, temperature, weather, user data, device information, etc.

In certain embodiments, the transaction management system 120 may transmit transaction data 114, possibly over a network, to a ledger corresponding to the index (e.g., corresponding in an index-to-ledger lookup table used to query a ledger identifier). In certain embodiments, the index and/or transaction management system 120 includes information about at least one node of a ledger corresponding to the index. The transaction management system 120 may transmit transaction data 114 to one or more nodes to be recorded on the ledger the node maintains and/or to one or more corresponding ledger mempools where transactions wait to be processed. The node may be indicated by the index or determined using the index. In certain embodiments, the index and/or transaction management system 120 includes information about a ledger block and/or an IP address or other network address to which the transaction data 114 is transmitted. In some embodiments, the index may be mapped to one or more ledger node address, possibly through a ledger name service. In addition to, or alternatively, the index may also be an address of a smart contract through which the transaction would be processed. Such an approach is useful in embodiments leveraging digital tokens (e.g., NFTs, composable tokens, etc.) for transactions that are managed by such smart contracts.

In certain embodiments, the transaction generation system may generate more than one index using device data 116 (e.g., using a function or more than one function, a location-to-index mapping function, etc.). For example, based on a first index, the transaction management system 120 may record first transaction data to a parent ledger 126 and based on a second index second transaction data to a child ledger 128 (e.g., in the ledger hierarchy 124). The first transaction data may be different than the second transaction data. The first transaction data may include a portion of the second transaction data or an indication of information included in the second transaction data. Such an approach is considered advantageous because it ensures proper coordination among related ledgers and provides for possibly recording unrelated transactions on distinct, but independent ledgers when necessary. Further, such an approach provides for separating data for security reasons. For example, the first transaction data may represent a healthcare transaction has occurred at a healthcare provider's facility, while the second transaction represents the specifics of a patient's treatment. Thus, the second transaction may be secured to retain compliance with HIPAA while still providing an indication of that the treatment took place without revealing the details or patient information.

In an example, the transaction management system 120 may record first transaction data to one or more ledgers (e.g., in the ledger hierarchy 124) indexed by location and record second transaction data to one or more different ledgers (e.g., in a different ledger hierarchy, among linked ledgers, etc.). Such embodiments may be useful when different transaction data can be determined from the device data 116 and used to record transaction data of different scopes on multiple ledgers. In one example, device data may include transaction information for a transaction that occurred in a shop of a shopping center. The transaction management system may generate first transaction data based on the device data and transmit the first transaction data to a first ledger that records transaction information in detail, such as transaction time, transaction value, seller identifiers, purchaser identifiers, and items purchased. The first ledger reflect the detailed sale information that occurred in the shop. The transaction management system may generate second transaction data based on the device data and transmit the second transaction data to a second ledger that records transaction information in a different level of detail than the first ledger. For example, the transaction data may include the transaction value and an identifier of the shop. The second ledger may reflect revenue for the shops in the shopping center. While shopping centers provide for a illustrative example, one should appreciate that other types of venues are also contemplated. For example, a sporting arena may have one or more ledgers corresponding to different event types (e.g., a football game, a baseball game, a truck pull, a convention, eSporting event, news event, military event, educational event, real-world asset event, healthcare event, logistic event, supply chain event, workflow event, project execution event, construction event, etc.). Thus, each ledger may be found based on the sporting arena's geo-location and each ledger may be found based on type. Further each ledger may record events that take place at the area, but only associated with the corresponding event type.

The transaction data 114 may include the device data 116, a portion of the device data 116, data determined using the device data 116, node information (e.g., a node uniform resource locator (URL), URI, etc.), a signature (e.g., a signature of the device 112, a signature of the transaction management system 120, etc.), an instruction (e.g., a burn instruction, a mint instruction, a transfer instruction, a trade instruction, an update instruction, etc.), a value (e.g., 1 ETH, 0.1 BTC, 5 USDC, 10 SOL, gas fees, fiat currency value, stablecoin currency, etc.), a wallet address (e.g., a wallet address of a receiver, a wallet address of the sender), and/or a smart contract address, mempool address, etc.

The ledger the transaction management system 120 accesses (e.g., transmits data to, transmits transaction data to, etc.) may be recorded on a set of one or more ledgers. The one or more ledgers may include a ledger hierarchy 124. The ledger hierarchy 124 may include ledgers with parent-child hierarchy relationships. The illustrated example shows that the ledger hierarchy 124 may include a parent ledger 126 and any number of child ledgers 128. The parent ledger 126 may itself have a child relationship to a parent ledger of the parent ledger 126. One should appreciate that other forms of ledger organizations are also contemplated. For example, rather than or in addition to a ledger hierarchy, multiple ledgers may be linked or crossed linked with each other forming a network of ledgers where each ledger may be a node in the ledger network, the ledgers may be linked together to form a graph, the ledgers may be linked into a tree structure, the ledgers may be organized into clusters, or the ledgers may be otherwise organized in a searchable or retrievable manner. In such embodiments, a ledger name service may be implemented that maps a ledger's name to actual ledger's location. Such a name service may convert a name of a ledger to a geo-location index, which in turn would point to the target ledger. Such names may be hierarchical in nature. For example, a ledger name such as USA.CA.OC.LAGUNAHILLS may point the ledger corresponding to the town of Laguna Hills, in Orange County, California, in the USA. This name could be resolved to a coordinate (e.g., lat 33.61321533228386, long −117.71173859184358) or an S2 cell identifier, for example, that could then be used to lookup the corresponding ledger. While this discussion relates to an index pointing to a ledger, one should appreciate the index may provide access to a ledger entry point through which transactions may be processed or recorded on the target ledger. Example entry points include node addresses, smart contract addresses, mempool addresses, or other ledger entry points.

The set of ledgers may include one or more of the following types of ledgers: a blockchain, a hashgraph, a directed acyclic graph, a holochain, a distributed ledger, a private ledger, a public, a semi-public ledger, etc. A ledger in the set of ledgers may be configured according to a different protocol than another ledger in the set of ledgers. For example, the first child ledger 128a may be configured according to an Ethereum protocol and the second child ledger 128b may be configured according to a Solana protocol. Other protocols may include a protocol for a hashgraph, a directed acyclic graph (DAG), a holochain, a linked list, or a distributed ledger.

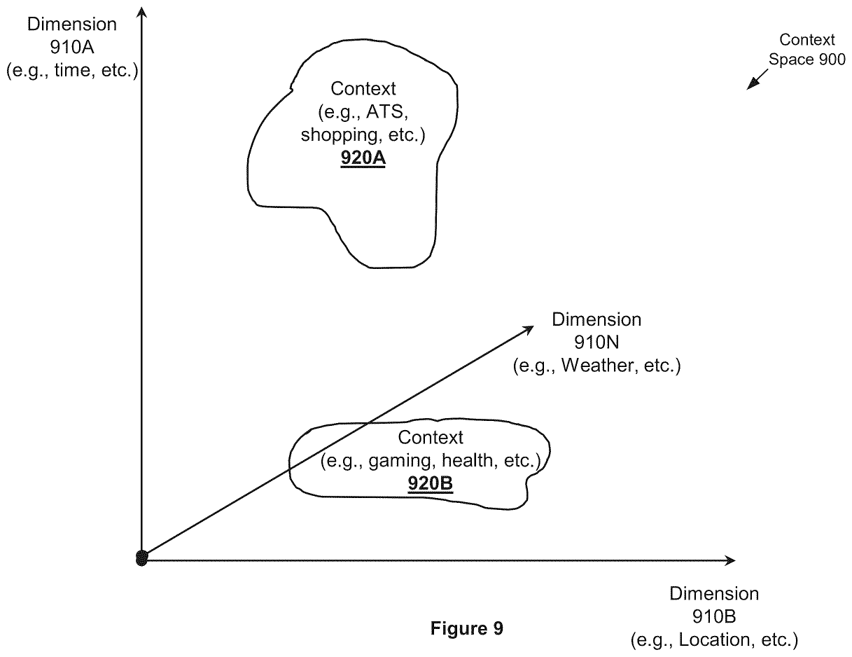

A ledger in the set of ledgers may be associated with a context, such as a location (e.g., a state, a postal code, a parking space, a room, a geofenced area, an S2 cell, a property boundary, etc.). Ledgers in the set of ledgers may be associated with different locations and/or more granular locations. For example, a parent ledger 126 may be associated with a state, and a first child ledger 128a may be associated with a city. In another example, parent ledger 126 may be associated with a city and the first child ledger 128a may be associated with a parking lot. Additionally, the first child ledger 128a may itself be a parent ledger to a different child ledger that is associated with a parking spot in the parking lot associated with the first child ledger 128a. In certain embodiments, the location (e.g., area, position, etc.) associated with a first ledger may overlap with a second location associated with a second ledger. A ledger corresponding to a parking space may be used to record transactions related to an owner of the parking space, who parks at the parking space, how long someone was parked at a parking space, rent for the parking space, payments for use, and/or reserving the parking space, etc. While the main examples provide for using locations of area, one should appreciate that a location could also be a volume or a set of volumes. For example, a ledger may be bound to a volume represented by a tall building's location and an elevation corresponding to set of one or more floors of the building. Thus, depending on the number of floors in the tall building, there may be multiple volumes of interest at a single location, each volume bound to the building's location, but also bound to different volumes. Therefore, ledgers may be bound to elevation or altitude as well as location. Such elevations may be positive (e.g., above sea level, above a reference height, etc.) or negative (e.g., below sea level, below a reference height, etc.). While these example represent volumes associated with a geolocation, one should appreciate the “volume” may also be associated with a multi-dimensional space having many different dimensions possibly including time, temperature, or other dimensions of relevant. Thus, a volume might represent an N-dimensional volume where N (e.g., N=2, N=3, N=10, etc.) represent a number of dimensions in the space (e.g., a location, an elevation, a period of time, a weather condition, etc.). Such N-dimensional spaces may be considered a context space through which indices may be found. Additional discussions regarding such context spaces may be bound in regards to FIGS. 9 through 11 below.

The illustrated system 100 shows that the parent ledger 126 may be associated with the parent location area 102. The parent location area 102 may correspond to a physical area (e.g., a city in the real world, a country in the real world, a home, a school, a mall, a jurisdiction, etc.). In certain embodiment, a location area may correspond to a virtual location area (e.g., a location area in a virtual world, a location area in a realm of a virtual world, a game base, etc.). The first child ledger 128a may be associated with first child location area 104. The first child location area 104 may be a subset of the area covered by the parent location area 102. The subset of the area may be a smaller area than the parent location area 102 and within the parent location area 102. Similarly, the second child location area 108, third child location area 110, and fourth child location area 106 may be a subset of the parent location area 102 and may each correspond to a second child ledger 128b, a third child ledger 128c, and a fourth child ledger 128d, respectively.

Although not illustrated, the child locations'areas may overlap. For example, first child location area 104 may include area in common with second child location area 108. Although not illustrated, in certain embodiments, the parent location area 102 may include portions of the area that are not covered by a child location area. Thus, in some embodiments, an area may be tessellated via cells or tiles that connect, but may or may not overlap each other.

In certain embodiments, a ledger may have more than one parent ledger 126. In certain embodiment, the child location area may remain the same size over time but may change location relative to other child location areas over time. For example, the child location area may correspond to a car and the car may move around a city that corresponds to the parent location area 102 over time. Alternatively, a ledger may represent a business owned by a business owner. As the owner moves the location of their business, the corresponding ledger may move locations. In such cases, the business ledger may also shift from one patient ledger to another. Consider a scenario where a business is located in an outdoor mall. The business's ledger may be the child of the outdoor mall's ledger. However, if the business moves from the outdoor mall to an indoor mall, then the business ledger may migrate to the indoor mall's ledger thereby migrating from one parent ledger to another. This can be achieved through use of digital tokens representing the business ledger where the business's digital token (e.g., an NFT, etc.) may be moved from one parent ledger to another. The move may be facilitated by burning the NFT on the outdoor mall's ledgers, then minting a new NFT on the indoor mall's ledger, for example.

The first child ledger 128a, second child ledger 128b, third child ledger 128c, and fourth child ledger 128d may be included in a ledger cluster. The ledger cluster may include two or more ledgers with a common parent ledger 126. The ledger cluster may include ledgers associated with a common index type (e.g., a geolocation index, a device index, a network address index, etc.), owner index, context index, and/or other type of index. The ledger cluster may include ledgers associated with a common location, device, network address, use, and/or ledger hierarchy 124 level. As previously discussed a sporting arena's location may have multiple ledgers forming a cluster where each ledger corresponding to a type of event hosted at the arena. In some embodiments, a ledger cluster may be associated with a geo-fence area, a collection of S2 cells, or other aggregate areas or volumes; for example, a neighborhood.

Once the transaction data 114 is transmitted to a ledger from the transaction management system 120, a transaction record may be instantiated in a device memory (e.g., device 112, transaction management system 120, a network device, etc.) or other computer readable non-transitory storage; the memory of transaction management system 120 for example. In some embodiments, the instantiated transaction record may be recorded on the target ledger or another ledger, while in other scenarios the instantiated record or its corresponding data may be stored in an off-ledger storage location. The transaction may memorialize the transaction data 114 by recording the transaction on the target ledger. For example, the transaction data may memorialize the transaction data 114 from device 112 in the fourth child location area 106 associated with a real-world geolocation and recorded on the ledger the transaction data 114 is transmitted to. In certain embodiments, the transaction record memorializes the transaction data 114 with respect to a real-world geolocation or associated context. For example, the fourth child ledger 128d can memorialize transaction data 114 associated with the fourth child location area 106.

A ledger transaction may be instantiated using the transaction data 114 and with a format consistent with other transactions included in the transaction record maintained by the ledger. The ledger transaction may include a fungible token (e.g., a token that is divisible and not unique, BTC, ETH, etc.) transaction, a composable token (e.g., a token that includes one or more other tokens, etc.) transaction, a collection token (e.g., a token that groups two or more tokens together, etc.) transaction, a non-fungible token (NFT) (e.g., a token that cannot be copied, substituted, or divided) transaction, or other token-based transaction. The ledger transaction may include a minting transaction, a transfer transaction, a purchase transaction, a vote transaction, a sale transaction, a burn transaction, a gas fee transaction, an update transaction, a move transaction, a copy transaction (e.g., copying a ledger to another ledger, to different computer readable memory, etc.), a smart contract deployment transaction, smart contract interaction transaction, or other transaction. The ledger transaction may also include generation of a genesis block of a ledger (e.g., the ledger on which the transaction is recorded) via which a new ledger may be minted.

The ledger transaction may include an index of the transaction and/or an index of a block of the ledger in which the transaction is included. The ledger transaction may include a transaction hash to uniquely identify the content of the transaction, a sender address (e.g., a wallet address associated with device 112, a wallet address of the sender, etc.) for the wallet that initiated the transaction, a recipient address (e.g., a wallet address to be a recipient of a transaction), a smart contract address, an amount, a fee, a gas fee, a data field and/or an event field. The data field may include information relevant to the transaction. When sending cryptocurrency or other transaction involving a receiver, the transaction data may include a message for the receiver, if deploying a smart contract it can include the code of the contract, and when transacting with a smart contract it can include details of the function invoked on the contract. The event field may include information about data output by a smart contract in a transaction.

In certain embodiments, the ledgers included in the ledger hierarchy 124 may be located at a common location or set of locations. In certain embodiments where the ledgers included in the ledger hierarchy 124 correspond to physical locations, ledgers may be stored in a computer memory physically located within proximity (e.g., within the bounds of, within a predefined distance, etc.) to the physical locations the ledgers correspond with. The location of memories where a ledger or portions thereof may be stored on may be determined based on whether the memories share a chassis, share a rack, are in proximity to one another, share a power source, share a network (e.g., local access network), and/or failure domains. In other embodiments, ledgers may be stored outside or remote from their corresponding physical or real-world locations.

An example ledger hierarchy 124 may include a hierarchy of an organizational structure including a corporation ledger including division child ledgers. The division ledgers including department child ledgers. The department ledgers including team or group child ledgers. The team ledgers including employee child ledgers, possibly assigned a desk location. Such ledgers may be useful to record contributions of different parts of an organization. The different portions of the organization may be compartmentalized or otherwise indexed based on location of the division, department, etc. and/or the organizational unit. As entities within the organization move or shift from one assigned location to another, the child parent relationship of the ledgers may be updated. For example, the parent may have a digital token representing a child ledger. The digital token may be moved to a new parent ledger. More specifically, in some embodiments, the child ledger, say an employee's ledger assigned to a desk location, may be represented as an NFT recorded on the parent ledger, say a division's ledger. If the employee is moved to a new division, the NFT may be assigned a NULL address on the previous division's ledger thereby indicating the NFT is no longer valid with respect to the old division's ledger and the NFT may then be recorded, possibly minted, on the new division's ledger.

As another example consider a device that may transmit device data to a transaction management system. The device data may include a device identifier, a device owner identifier, a user identifier, a network address, a department identifier, a file handle, a location identifier, and/or a credential received from the device. The transaction management system may determine that the device data is associated with at least a first ledger for a first department. For example, a file may have been accessed by a user identified by a first user identifier. The transaction management system may determine that the user identifier is associated with the first department. A record of the file access may be stored on the first ledger so that the first ledger can record actions performed by users assigned to the first department. A parent ledger of the department ledger may be a first organizational unit ledger. The organizational unit ledger may record state information of the first ledger and any number of other department ledgers. The organizational unit ledger may record user identifiers assigned to each department and keep track of their respective file access events, or other access events such as building access events (e.g., to track productivity, to track attendance, etc.). Such a ledger hierarchy may be useful so that the organization unit ledger can track higher level access information than the access information maintained by the department ledger.

An example ledger hierarchy 124 may include a hierarchy of a legal system possibly including a supreme court ledger that further has child ledgers including appellate court child ledgers. The appellate ledgers may then include trial court child ledgers. The trial court ledgers may then include specialized court (e.g., family court, small claims court, etc.) child ledgers. Such ledgers may be useful to record a history of litigation, rulings, court appearances, sitting judges, clerks, and/or courtroom officers, filed documents appeals from one court to a higher courts, etc. The ledgers may be indexed based on a court system or their jurisdictions. It should be appreciated that a ledger hierarchy or other ledger organization may include any practical number of levels or layers. Thus, each parent may have more than one child and in some embodiments a child may have more than one parent.

For example, court appearance information including a counsel identifier, a time, and a location may be included in device data transmitted to a transaction management system. The transaction management system may use the court appearance information to determine that the court appearance information should be recorded on a ledger corresponding to the type of court (e.g., family law) that was in session at the time and place represented by the court appearance information. Further, decisions from each court may be recorded as digital tokens on their respective ledgers. In this example, it is possible the identifiers do not necessarily have to be location identifiers, but could also include other identifiers as indicated (e.g., counsel identifier, a time, etc.). Thus, the corresponding ledgers may be indexed by additional identifiers or context attributes for ease of lookup or retrieval, possibly via a multi-dimensional query.

In another example, a child ledger may be used to record first rulings and first related information for district court cases and the parent ledger may be used to record second rulings and second related information for appellate court cases. The appellate court cases may have originated from a court associated with the child ledger. The parent ledger associated with the appellate court may include a NFT that points to the child ledger. The NFT may represent the ruling or other case information.

An example ledger hierarchy 124 may include a hierarchy of an educational system including a school district ledger further including school child ledgers. The school ledgers may then include grade child ledgers. The grade ledgers may then include class child ledgers. The class ledgers may then further include student child ledgers. Such ledgers may be indexed based on location and/or based on an account classification such as a student, teacher, administrator, class, equipment, etc. In an example, student laptop devices transmit activity data to the transaction management system as device data. The transaction management system can determine a classroom that the student is located in at the time the device data is transmitted, possibly based on an IP address. Alternatively, for example, the transaction management system may cross reference a student schedule with a student identifier included in the device data to determine a classroom the student is in, or should be in. The transaction management system may maintain a mapping of which classrooms correspond to which student identifiers based on the time of day (e.g., at 8 AM student A is in classroom A, at 10 AM student A is in classroom B, etc.). The transaction management system may transmit the activity data to a ledger associated with the classroom. A teacher of the student may be able to view the activity data recorded on the classroom ledger to monitor student learning. Certain activity data, such as test grades, may be additionally transmitted to a school ledger. Activity data of the teacher may be included in device data and transmitted to the transaction management system for the transaction management system to then record the activity data on the school ledger. In a school environment, the hierarchy of ledgers may also be useful for tracking substitute teachers being used throughout a school district, visitors, and/or sickness, etc. Thus, as students, teachers, administrators, equipment, or other entities move about, their events may be recorded as transactions on the corresponding ledgers.

An example ledger hierarchy 124 may include or operate as a hierarchical file system including a root directory ledger (e.g., parent ledger) pointing to subdirectories (e.g., child ledgers). The subdirectory may further point to folder child ledgers. The folder ledgers may further point to subfolder child ledgers and/or file child ledgers. The subfolder ledgers may still further point to file child ledgers. The ledgers may be useful to track memory, possibly a distributed computing memory, of a file system over time, document history, application information, documents assigned to profiles, etc. The ledgers may be indexed based on a file path, also referred to as a file location. In some scenarios such a ledger hierarchy may be useful for tracking how memory was used and/or what occupied memory at a certain part of a file path/file directory. When a file or other data in a file path is added, removed, or edited, the ledgers at a corresponding index may be updated to reflect the file or other data being added, removed, or edited. Such a ledger hierarchy may be useful to show incremental changes to files and/or applications over time, or otherwise operate as a journalling file system. This may be useful to roll back changes, determine contributions, and/or perform validation checks on applications to ensure that the application has not been changed without authorization. Thus, the ledger hierarchy 124 may facilitate formation of a distributed journalling file system. Example distributed storage techniques that may be adapted for use in such a ledger-based file system can be found in U.S. Pat. No. 9,509,803 to Soon-Shiong titled “Distributed Storage Systems and Methods,” filed on Oct. 8, 2013, and U.S. Pat. No. 11,662,939 to Bassett titled “Object Storage and Access Management Systems and Methods,” filed May 10^{th}, 2021, these and all other extrinsic references are hereby incorporated by reference in their entirety for all purposes.

An example ledger hierarchy 124 may represent managed ledgers for different types of assets or entities (e.g., virtual assets, real-world assets, real-estate, buildings, monetary or assets exchanges, tangible assets, intangible assets, intellectual property or rights, etc.). For example, ledger hierarchy 124 may represent a hierarchy of a products including a main product category (e.g., electronics, etc.) ledger that may also include subcategory (e.g., smart watches, smart phones, etc.) child ledgers. The subcategory ledgers may further include brand child ledgers. The brand ledgers still further may include specific product child ledgers. Such ledgers may be useful to enable tracking of product catalogs over time, sales, discounts, reviews, and/or recalls. The ledgers may be indexed based on product information as part of a context. When a product is added to a online catalog, product information may be included in device data. The device data may include a virtual location of where the product is being added, such as Retailer>Electronics>Phones. The virtual location may be used to add transaction data to one or more of a retailer ledger, an electronics ledger, and/or a phones ledger with product data.

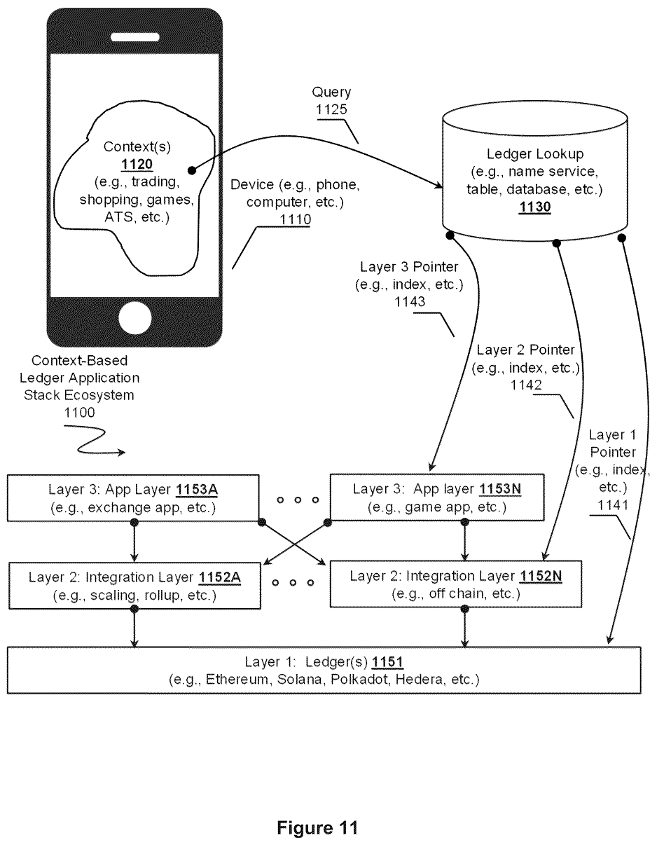

An example ledger hierarchy 124 may include a hierarchy of software including a system ledger that may include subsystem child ledgers. The subsystem ledgers may also include module child ledgers. The module ledgers may further include component child ledgers. The component ledgers be further refined via function child ledgers. Each ledger in the hierarchy may represent different layers in an application stack as discussed further with respect to FIG. 11. For example, one ledger may represent a layer 1 level of infrastructure, possibly even a notarized ledger such as Ethereum while a second ledger may represent a layer 2 level of infrastructure, possibly service layer operating on Ethereum (e.g., side chain, off chain processing, optimistic rollups, zero knowledge rollups (ZK rollups), smart contract, etc.). Such ledgers may be useful to enable software development over time. The ledgers may be indexed based on a file path context. When an addition, change, copy, move, backup, or deletion of code is performed, the virtual location of the code may be used to record how the code was changed. The virtual location may be indexed based on the Software Application>Subsystem>Module>Component. The virtual location may be used to add transaction data to one or more of the software application, the subsystem, the module, or the component ledgers to reflect a software development action performed. Thus, in some embodiments, the inventive subject matter of location-based ledgers may be integrated into version control systems (e.g., Git, BitBucket, Mercurial, Perforce, etc.) where the ledger records what changes occurred to the code and which location caused the change.

A further example ledger hierarchy 124 may include a hierarchy of a military structure including an army ledger further including subsystem corps ledgers. The corps ledgers may then include division child ledgers. The division ledgers may further be refined via brigade child ledgers. The brigade ledgers still further include battalion child ledgers. The battalion ledgers additionally may include company child ledgers. The company ledgers may include platoon child ledgers, etc. The ledgers may be useful to track make up of groups of those enlisted, where devices associated with users of a given status have been located, rank changes, jobs, etc. The ledgers may be indexed based on a rank or rank context. As an example, when a room is being accessed by a device such as a near field communication badge, a device reader may transmit device data to a transaction management system. The device data may include a user identifier. The transaction management system can record the access attempt to one or more ledgers based on the rank of the user, thereby enforcing security or permission levels.

An example ledger hierarchy 124 may include a hierarchy of a government that may include a federal government ledger which then may include state or province government child ledgers. The state government ledgers may then include county government child ledgers. The county government ledgers may include city government child ledgers. The city government ledgers include municipality or precinct child ledgers. Such ledgers may be useful to enable tracking of personal, regulations, and laws over time. The ledgers may be indexed by government level, for example, a government level associated with device data. As an example, when a law or regulation is enacted, it may be recorded on a ledger based on a jurisdiction that the law can be enforced. A local regulation may be recorded within a federal>state>local ledger hierarchy such that is recorded on the local ledger.

Yet another example ledger hierarchy 124 may include a hierarchy of an information technology infrastructure that may include a data center ledger which may then include subsystem server child ledgers. The server ledgers may then include virtual machine child ledgers. The virtual machine ledgers may then include application child ledgers. The application ledgers might further include service child ledgers. The hierarchy of ledgers can be used to track device data associated with a virtual location, the virtual location corresponding to a service, an application, a virtual machine, etc. As alluded to previously, the hierarchy may actually be levels of a ledger-based application stack. In such cases, virtual machine ledgers may be instantiated or deconstructed as they appear and then are detected. However, their existence may be tracked via corresponding digital tokens on their parent ledgers, thereby creating an audit trail for possible service level agreements.

Still further an example ledger hierarchy 124 may include a hierarchy of a supply chain including a supplier ledger that can include manufacturer child ledgers. The manufacturer ledgers may further include distributor child ledgers. The distributor ledgers may then include retailer child ledgers. The retailer ledgers could then include customer child ledgers. In certain embodiments, a ledger may be instantiated and correspond to production during a specific time period, for a specific purchasing entity, and/or at a specific facility. The ledgers may be indexed by product or category of products or other supply chain indices. The hierarchy of ledgers can be used to track how products have been received, moved, stored, and/or distributed by different parts of a supply chain.

An example ledger hierarchy 124 may include a hierarchy of academic disciplines including a discipline ledger that may include sub-discipline child ledgers. The sub-discipline ledgers may then further include field child ledgers. The field ledgers may then include specialization child ledgers (e.g., degrees, universities, colleges, laboratories, etc.).

An example ledger hierarchy 124 may include a hierarchy of ledgers for project management including a portfolio ledger that includes program child ledgers. The program ledgers may further include project child ledgers. The project ledgers may then further include task child ledgers. The task ledgers may still further have sub-task child ledgers. The ledgers may be indexed based on a client, a project manager, a year, a project, and/or a location.

An example ledger hierarchy 124 may include a hierarchy of ledgers for an amusement park including attraction (e.g., ride, games, food, etc.) child ledgers. The ledgers may be indexed based on location as described in other embodiments herein.

In certain embodiments, a hierarchy of ledgers may include ledgers corresponding to rental properties, mortgaged properties, taxable assets, food trucks, reservations, rooms in a medical facility, etc. The ledgers may be indexed based on a location and/or a type of asset (e.g., real-world assets, real-estate, mortgaged property, etc.).

An example ledger hierarchy 124 may include a hierarchy of a documents including a library ledger that includes documents child ledgers. The documents ledgers might include book, magazine, and/or video child ledgers. The book, magazine, and/or video ledgers may further include title child ledgers. The title ledgers may still further include chapter child ledgers. Thus, ledgers may be indexed by document-based contexts. For example, ledgers may be identified by library, shelf, book, page, or other document-based indices.

An example ledger hierarchy 124 may include a hierarchy of ledgers for corporate governance including a board of directors ledger that might point to executive management child ledgers. The executive management ledgers might then point to middle management child ledgers. The middle management ledgers may further include operational staff child ledgers. Such a hierarchy of ledgers may be useful to enable access control to information in the ledger hierarchy 124. The transaction management system 120 may be configured to enable read and/or write access from/to ledgers based on the device 112 being used and/or a user associated with the device 112. Such a hierarchy of ledgers may be used for auditing of a corporation. Example corporate indices that may be used to index ledgers may include a corporation name, a subsidiary name, a corporate identifier, an address, a department identifier, a team or group identifier, an employee identifier (e.g., employee number, social security number, etc.), or corporation related information.

In certain embodiments, the index generation system 122 may receive device data (e.g., an image, a video, audio, temperature, GPS, location data, sensor data, user data, etc.) and use the device data to determine one or more descriptors derived from the device data, which may represent one or more contexts of the device. The descriptor may be generated using a machine learning model. For example, the machine learning model may include an image-to-text machine learning model (e.g., a Bootstrapping Language-Image Pretraining (BLIP) model, an optical character recognition (OCR) model, etc.). The image-to-text machine learning model may generate a description of the image. The description may include an index or be used to determine an index (e.g., using techniques described above such as hashing, etc.). In certain embodiments, the device data may be input into a large language model (LLM) alongside a predefined prompt that causes an identifier to be determined or generated based on a prompt derived from the device data. The identifier may correspond to a ledger and can be used to access the ledger. The identifier may include one or more index.

In certain embodiments, non-fungible tokens (NFTs) can be used to provide functionality other than representing ownership of an asset (e.g., a real-world assets (RWA), a virtual assets, a stock, a collateral, a mortgage, a currency, real-estate, baseball card, a car, a name, an image, a likeness, intellectual property, a copyright, a patent, a trademark, a trade secret, etc.). In certain embodiments, NFTs can operate as a security token, enabling a device associated with the owner address to read to, write to, manage, control, and/or edit one or more child ledgers and/or parent ledgers. In an example use case, when the device 112 is located in the parent location area 102, the device 112 may be capable of causing the parent ledger 126 to be accessed (e.g., writing data and/or reading data to and/or from the parent ledger 126, manage, etc.). A wallet address associated with the device 112 may be associated with an NFT. For example, the NFT may be owned and/or managed via the wallet address. The NFT may operate as a security token, enabling the device 112 to access one or more child ledgers 128 of the parent ledger 126 when the device 112 is located in a corresponding location area or otherwise satisfied the context associated with the NFT. For example, the device 112 may be located in the fourth child location area 106 and the NFT may enable the device 112 associated with the wallet address to access the fourth child ledger 128d. In certain embodiments, the NFT is burned (e.g., transferred to a NULL owner address, etc.) when the device 112 leaves the parent location area 102 and/or the fourth child location area 106. In certain embodiments, the NFT is burned after a certain amount of time after the device 112 leaves the parent location area 102 and/or the fourth child location area 106 without returning. In certain embodiments, a ledger corresponding to a location area may not be accessed until one or more NFTs have been obtained.

In certain embodiments, a ledger corresponding to a location area may not be accessed until the device 112 has been located in one or more of the other location areas, possibly based on GPS device data. For example, the fourth child ledger 128d may not be accessed by a wallet associated with the device 112 if the device 112 has not first recorded a transaction on the third child ledger 128c and/or the parent ledger 126 indicating the device has been located within the third child location area 110. The location areas that the device 112 has been located in and other information about the location (e.g., how long the device 112 was located in the area, a speed of the device 112, etc.) may be stored on one or more ledgers associate with the respective area. For example, the parent ledger 126 corresponding to the parent location area 102 may record transactions and/or NFTs that indicate locations of the device 112 over time. Thus, tracking a device's movement in or through various areas and the device's interactions with corresponding ledgers may be used to give rise to additional utility. In some scenarios such tracking may be used for security purposes where the device satisfy a context that might require a specific set of movements and/or interactions to unlock access to additional ledgers. Further, such techniques may be used for location-based mobile games where the movements and/or interactions unlock content. Thus, a person or other entity (e.g., robot, etc.) may need to perform a certain choreography before access is granted to the additional ledgers. Therefore another aspect of the inventive subject matter includes defining such choreography or location-based paths for security purposes and binding to the corresponding ledgers.

In an example use case, the ledger hierarchy 124 may be indexed based on a network location. In such a use case, the fourth child location area 106 may represent a subnet and the parent location area 102 may represent a network that includes the subset and zero or more other subnets. The parent ledger 126 for the network may be used to assign admin rights to subnets, record high level network traffic, grant network access permissions, etc. As an example, the network access permissions can be granted via ownership of an NFT. Device data 116 generated from within the subnet may be recorded on the fourth child ledger 128d that is associated with the fourth child location area 106. The ledger hierarchy 124 may be indexed based on addresses (e.g., a sender address and/or receiver address, etc.) included in packets transmitted by the device 112 and/or received by the device 112. The ledger hierarchy 124 may be used to track network activity and can be used to perform log analysis in the case of a network security breach and/or to detect suspicious activity. In certain embodiments, a network address (e.g., MAC address, IP address, URL, URI, DOI, HOI (see U.S. Pat. No. 11,017,897 to Soon-Shiong titled “Healthcare Management Objects” filed at a PCT application on March 22^{nd}, 2012, this and all other extrinsic references are hereby incorporated by reference in their entirety for all purposes), etc.) may be used for indexing the ledger hierarchy 124.

In an example use case, the ledger hierarchy 124 may correspond to virtual location areas where a virtual character may be located at the virtual location area (e.g., a virtual fourth child location area 106). For example, the parent ledger 126 may record transaction data 114 related to a virtual land parent location area 102 in a game (e.g., a video game, an AR game, a VR game, a mobile location-based game, on-line game, MMORPG, etc.) and the fourth child ledger 128d may record transaction data 114 related to actions performed by the virtual character in the fourth child location area 106. The fourth child location area 106 may represent a merchant (e.g., stationary, non-stationary, caravan, shop, traveling merchant, etc.) in the game, player housing, a dungeon, a battleground, a zone of a virtual world, etc. In certain embodiments, the fourth child location area 106 is an area around an NPC and the NPC may move around a virtual world. The ledger hierarchy 124 may be indexed based on a virtual location in addition to, or as an alternative to, a location of device 112. The virtual location of the player may be transmitted to the transaction management system to determine one or more ledgers in the ledger hierarchy 124 to access. In such a use case, the NPC may be represented on the ledger or ledgers as an NFT where the NFT may include a pointer to off ledger data representing the NPC's behavior profile, possibly governed by a large language model (LLM) operating on a system prompt representing the NPCs personality. As the NPC moves from one location to another, the corresponding NFT may be transferred to a corresponding ledger.

Further, a portion of the NPC's NFT's owner address (e.g., one or more bit fields, etc.) may be updated to reflect the state of the NPC, possibly as it pertains or relates to the corresponding location. Using an NFT's owner address to represent state may be adapted from the discussion in U.S. Pat. No. 11,880,824 to Witchey et. Al. titled “Managing Digital Blockchains via Digital Tokens Systems, Methods, and Apparatus,” filed April 6^{th}, 2023, this and all other extrinsic references are hereby incorporated by reference in their entirety for all purposes.

In an example use case, the ledger hierarchy 124 may include a parent ledger 126 for a building and child ledgers 128 for floors of the building. The child ledgers 128 may record transaction data that relates to conception, design, construction, maintenance, blueprints, or even demolition of a corresponding building. The parent ledger 126 may include NFTs that point to the child ledgers 128. In certain embodiments, an NFT is owned by a wallet address that corresponds to an owner of a business occupying the floor of the building. A managing device of the building may be enabled to monitor a subset of activities occurring on each floor's ledger. The ledgers may be indexed by floor number. The parent ledger 126 may include a set of NFTs that have identifiers that serve as the index generation system 122. For example, if the building includes twenty floors, the parent ledger 126 may include NFTs with identifiers, possibly numbered 1-20. NFTs may be minted and burned when floors are added or removed. The NFTs may point to respective child ledgers 128 and therefore may serve as a lookup table and the index generation system 122. Such an indexing system may be hierarchical in nature. For example, an indexing structure could include a building identifier (e.g., BLDG1) and floor identifier (e.g., F1, F2, B1, B2, etc.) and say an apartment identifier (e.g., A123, A567, etc.).

Thus, an index might be of the for “BLD1.F5.A510.” Such an approach is advantageous because each portion of the address may point to a different ledger. The BLD1 portion would represent the index for the parent ledger for the building. The BLD1.F5 (floor 5 of building 1) would point to the floor-specific child ledger of the building ledger, and the BLD1.F5.A510 would point to apartment 510's ledger which would be a child of the floor ledger.

In an example use case, the ledger hierarchy 124 may include a biological location. For example, a biological location may include a heart, a lung, a right hand pointer finger, a torso, an ulna, etc. The ledgers may be indexed based on the biological location. Each ledger may record transaction data associated with the biological location (e.g., a vaccine, a diagnosis, symptoms, surgery, donors, treatment, amputation, etc.). Still further, ledger may be indexed based on familial relationships. A father might have a ledger that includes pointers to a son or daughter, which may further have ledgers pointing to grandchild ledgers. Thus, ledgers can form a family hierarchy of ledgers.

In an example use case, location of objects on a movie set may be used to index the ledger hierarchy 124. For example, the device data 116 may include location data for one or more object on a movie set. The location on the movie set may correspond to a parent location area (e.g., the parent location area 102) and/or a child location area (e.g., the fourth child location area 106). The device data 116 including the location data for the one or more object on a movie set may be used to record object position data over the course of filming a movie. The object positions may be recorded so sets can be reproduced subsequently. Object positions may include props, people, cameras, backdrops, images on a screen backdrop, etc. Such applications may be used for previs work or project management through production of a movie.

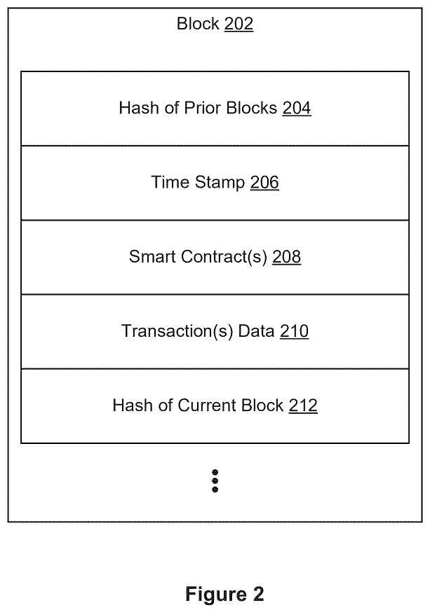

FIG. 2 illustrates a block diagram of a blockchain block according to certain embodiments, in accordance with the present disclosure.

Blockchains, or other notarized ledgers, are comprised of structured data that are called blocks. A block 202 may include a cryptographic hash (a unique identifier) of the previous block 204 to prevent any block from being altered or the sequence of blocks from being altered. A blockchain is essentially a write-once-at-the-current-block, read-many-blocks type of system. A block 202 can be written to the blockchain, but it may then only be read from, it cannot be altered and preferably represents immutable data. A block 202 may also include a time stamp 206 of when transactions were recorded. Each block 202 may further include a hash of the current block 212, representing the hash value of the block 202 after the block 202 has obtained a batch of one or more valid transactions to be included within the block 202 on the blockchain. Additionally, a block 202 may represent other data such as smart contracts 208 or transaction data 210, which may be stored off ledger. A block 202 may include zero or more transactions represented as transaction data 210. Additionally, or alternatively, a block 202 may represent zero or more smart contracts 208. In certain embodiments, the number of transactions (represented by transaction data 210) and/or smart contracts 208 that may be associated with block 202 may be limited by the amount of time a block 202 takes to be validated by the network. Further, transaction data 210 in a block 202 may include high level information about the transaction such as that the transaction was a minting transaction, a ledger-to-ledger transaction, a copy transaction, a burn transaction, an ownership transaction, a transfer transaction, a purchase transaction, a vote transaction, a sale transaction, an exchange transaction, a smart contract deployment transaction, or smart contract interaction transaction, etc. On the other hand, transaction data 210 in a block 202 may be more specific such as that an NFT transferred ownership or what the NFT data represents. In certain embodiments, transaction data 210 of a first size is stored on the blockchain while at least a portion of the transaction data of a second size is stored off of the blockchain because of the attributes the data has (e.g., data size, transaction type, etc.) might not be practical to store on-ledger. In certain embodiments, high-level transaction data 210 is stored on the blockchain and the high-level transaction data 210 includes a pointer (e.g., URL, URI, DOI, HOI, link, filename and path, address, etc.) to where the lower-level data is stored (e.g., where the off-chain storage is, IPFS, CEPH, etc.) off-ledger.

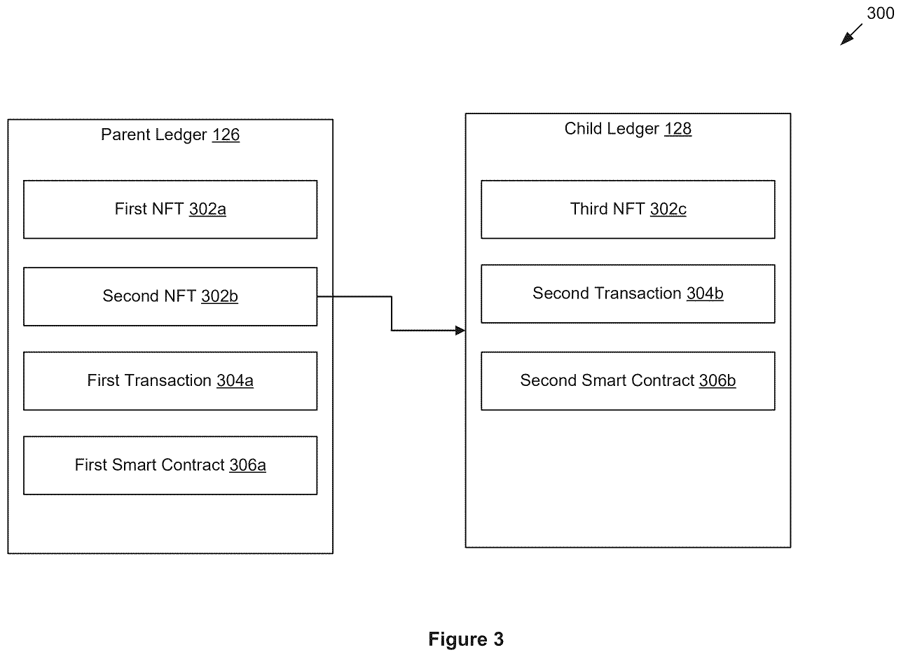

FIG. 3 illustrates a block diagram 300 of a parent ledger 126 and a child ledger 128 and their relationship relative to each other according to certain embodiments, in accordance with the present disclosure. The parent ledger 126 may be the parent ledger 126 or another parent ledger described with respect to system 100. The child ledger 128 may be one of the child ledgers 128 described with respect to system 100. Additionally, the parent ledger 126 and the child ledger 128 may have a hierarchical relationship or linked relationship with one another as described with respect to system 100. The parent ledger 126 may itself be a child ledger to another ledger and the child ledger 128 may itself be a parent ledger to another ledger. In other embodiments, parent ledger 126 may be a layer 1 notarized ledger (e.g., Ethereum, Solana, etc.) while child ledger 128 may be a layer 2 operating on the corresponding notarized ledger. Ledger layers and ledger-based application stacks are discussed further with respect to FIG. 11 below.

The hierarchical relationship of the parent ledger 126 and the child ledger 128 may be useful for indexing the ledgers. The ledgers may be indexed based on a virtual location, a physical location, altitude, context, or a position (e.g., position in an area, a space, an organization, etc.). Storing ledgers in the hierarchical or otherwise linked relationship is beneficial because data can be organized in a structured and logical manner, allowing users and systems to efficiently locate, access, and manage data quickly. The ledger hierarchy can also provide a framework for categorizing device data, ensuring consistency, and improving efficiency of a ledger system through the disclosed fast indexing schema no matter where ledger data may be physically located. The hierarchy can enable improved navigation because the ledgers can be organized in a tree-like structure with ledgers and sub ledgers, making it easier to locate specific data. Further, the indexing of ledgers can help optimize storage utilization, distribution where data is stored and/or the hardware of ledgers. The hierarchical relationship can also improve access control, by enabling ledger access controls at different levels (e.g., based on NFT ownership), thereby enhancing data integrity, availability, and confidentiality. Another benefit of a hierarchical ledger system is that the structured approach can support the addition of new ledgers without disrupting the overall system. Such ledgers can be added, even if the protocols of one ledger vary from another ledgers in the hierarchical relationship because each ledger in the hierarchy is separate.

Parent ledger 126 may record tokens (e.g., NFTs, fungible tokens, composable tokens, etc.), transactions, and/or smart contracts, etc. As an example, parent ledger 126 is illustrated to include a first NFT 302a, a second NFT 302b, a first transaction 304a, and a first smart contract 306a.

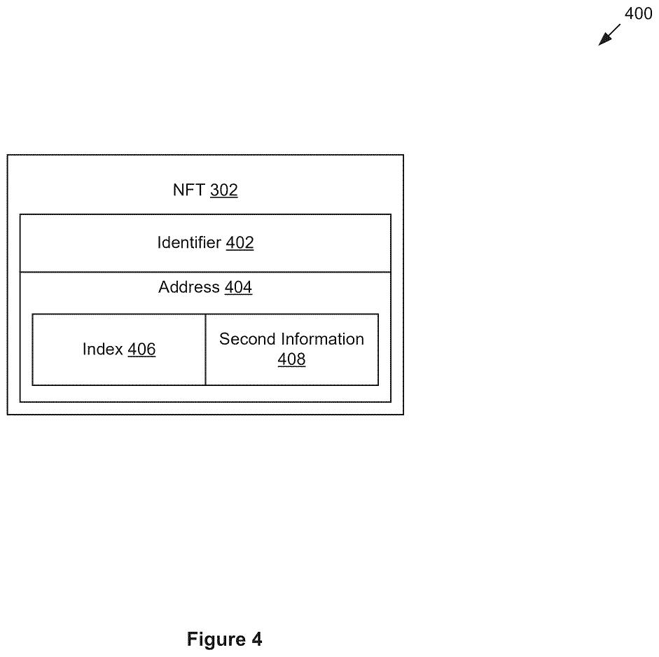

The first NFT 302a and second NFT 302b may be configured to link the parent ledger 126 with the child ledger 128 and is described further with respect to FIG. 4, below. For example, the second NFT 302b may include a pointer to the child ledger 128 and/or an index identifying the child ledger 128. Thus, the pointer may be a direct pointer to child ledger 128 or an indirect pointer that points to other data that may be used to access child ledger 128 (e.g., a look up table, hash table, a ledger name service, etc.). The second NFT 302b may represent ownership of the child ledger 128. The second NFT 302b may include state information associated with the child ledger 128. It should be appreciated that while second NFT 302b points to child ledger 128 thereby establishing the parent-child relationship, the reverse could also be true. For example, third NFT 302c recorded on child ledger 128 may point back to parent ledger 126. Thus, ledgers may point or link to each other in a bidirectional manner. Still further, while parent ledger 126 and child ledger 128 are illustrated as a hierarchy it should be appreciated that other data linking schemas are possible including graphs, networks, directed acyclic graphs (DACs), cyclic graphs, directed graphs, complete graphs, a queue, a double ended queue, linked list, or other form of interconnected ledger data structures that form more functional and capable ledger systems.

State information of the child ledger 128 may represent the current status (e.g., on, off, state machine state, active, deactivated, NULL state, locked, etc.) and/or snapshot of all data stored by the child ledger 128. The snapshot may include a representation of one or more account balances, security exchanges, contract code, or storage data. The state may include a reflection of all the transactions and operations that have taken place up to a given point in time. The state information may be updated when the child ledger 128 records a transaction or records a block or otherwise when a change to child ledger 128 occurs or is detected.

Child ledger 128 may record tokens, transactions, security exchanges, RWA transactions, smart contracts, or other data. As an example, child ledger is illustrated to include a third NFT 302c, a second transaction 304b, and a second smart contract 306b. Child ledger 128 may perform similar operations and include data similar to the parent ledger 126. The third NFT 302c may point to yet another child ledger of the child ledger 128. The third NFT 302c may point to the parent ledger 126 as referenced above. The third NFT 302c may include similar information as the second NFT 302b, but for the parent ledger 126 (e.g., parent ledger 126 state information).

FIG. 4 illustrates a block diagram of a possible non-fungible token (NFT) 302 according to certain embodiments, in accordance with the present disclosure. NFT 302 may be the first NFT 302a, second NFT 302b, or third NFT 302c as described above with respect to FIG. 3.

NFTs may comprise various forms of data to represent an asset; possibly including a real-world asset (RWA), a virtual asset, collateral, a tangible asset, an intangible asset, a name, an image, a likeness, a copyright, a license, a patent, a trademark, a trade secret, a contract, or other type of asset. The data included within or associated with an NFT 302 may comprise an identifier 402 and/or an address 404. The identifier 402 is typically unique to the ledger that the NFT 302 is minted on, and identifies the NFT. In certain embodiments, the NFT 302 identifier 402 is unique across more than one ledger. The identifier 402 may be represented with a hash value, a globally unique identifier (GUID), a universally unique identifier (UUID), a number, a name, 256-bit value, 512-bit value, etc. The identifier 402 may correspond to a child ledger of the ledger that the NFT is recorded on. In certain embodiments, NFT identifiers may be close in value when the NFTs were generated at a similar time. In certain embodiments, the identifier of the NFT may indicate the order in which the NFTs were minted. For example, identifier 402 may be represented by a counter that increments when NFTs are generated according to a common smart contract interface.

In the case of a geolocation NFT, an NFT that corresponds to a location, the identifier may be similar (e.g., close in numerical value, close in alphabetical order, etc.) to identifiers of other NFTs recorded on the same ledger as the NFT when the other NFTs corresponding to ledgers associated with locations that are relatively close in proximity to the location associated with the ledger corresponding to the NFT 302. Thus, identifier 402 of NFT 302 may be a pointer to or link to a child ledger. Still other fields in NFT 302 may also be present that may be a pointer to a child ledger. This approach is can be considered quite advantageous because it can provide for using NFT 302 as a digital token representing ownership of the child ledger. Said differently, the child ledger can now be treated as an actual asset via NFT 302; an actual asset that can be traded, sold, created (e.g., minted) or otherwise instantiated, deleted or destroyed, or otherwise managed via the corresponding smart contract managing NFT 302.

The address 404 included within NFT 302 may be of any practical length and typically represents an owner of NFT 302. For example, the address 404 length may be 256 bits. In certain embodiments, the address 404 represents the unique owner address (e.g., wallet address of an owner, an owner identifier, etc.) associated with an owner of the NFT 302. The bits within the address 404 field of the NFT 302 may represent many different pieces of information or objects, limited only by the size of the bit field, possibly a unitary bit field. Thus, the inventive subject matter is considered to include extending the functionality of the NFT owner address to include ledger management features via one or more bit fields. Example techniques for managing bit fields of NFTs may be adapted, as discussed below, from U.S. Pat. No. 11,880,824 to Witchey et. Al. titled “Managing Digital Blockchains via Digital Tokens, Systems, Methods, and Apparatus,” filed on April 6^{th} 2023, this and all other extrinsic references are hereby incorporated by reference in their entirety for all purposes.

In certain embodiments, the address 404 field of the NFT 302 includes two or more separate fields that are less than the size of the address 404 field so that the address 404 field may represent more than one piece of information. For example, the address 404 field of the NFT 302 may include two fields. A first field of the two fields may represent an index that corresponds to a ledger in a hierarchy of ledgers. The index may be an index of a ledger that is a parent or a child to the ledger the NFT is recorded on. As described above, the ledger in a hierarchy of ledgers may correspond to a location. Accordingly, the index included in the address 404 field may correspond to the location (e.g., S2 cell identifier, network address, geolocation coordinate, address, geohash identifier, zip code, etc.). As alluded to above, the index of the first field may also represent a context identifier which is bound to the corresponding target ledger and through which the target ledger may be found.

A second field of the two or more fields in address 404 may represent second information. The second information may include state information (e.g., state information of a child ledger, state information of a parent ledger, etc.). The state information may represent a change to data recorded on a ledger corresponding to the NFT and other than the ledger the NFT is recorded on. In certain embodiments, the state information is updated based on updates or edits related to a ledger the NFT is corresponding to, such as a child ledger (e.g., a block is added to the ledger, transactions are added to the ledger, the ledger is turned on or off, the ledger state changes, etc.). By changing the state information and/or other bits of the address 404 field over time, the size of transactions related to the NFT can be reduced which can enable a reduction of computational strain on a network. As referenced above, the technology referenced in U.S. U.S. Pat. No. 11,880,824 may be adapted for use in tracking target ledger states via one or more fields in address 404.

The address 404 may include an owner identifier (e.g., wallet address of the owner, unique owner, owner entity, etc.). The owner identifier may represent a unique identifier of an owner of the NFT 302 and may not change until the owner of the NFT 302 (or, equivalently in some embodiments, the owner of the ledger pointed to by the NFT) changes. In certain embodiments, bits in the address 404 bit field may represent a URL and/or a pointer/file handle into a file system (e.g., local file system for the target ledger, IPFS, CEPH pool name, etc.). While the above example provides for splitting address 404 into multiple fields, it is also contemplated that a NFT may include a first address field representing one or more wallet addresses and one or more additional fields representing the index and/or the second information. In certain embodiments, the address 404 includes a bit field of a first length, and a portion of the bit field can be used to represent an address (e.g., a wallet address), a second portion can represent index 406, and a third portion can represent second information 408. The disclosed approach provides the advantage of creating greater functionality of disclosed NFTs, especially NFTs or other digital tokens representing target ledgers, without requiring a change to existing and established ledger or NFT infrastructure.

In certain embodiments, the complete address 404 bit field or portions of the address 404 bit field may represent a pointer to a block, a transaction, data, a smart contract, an NFT, etc. on a child ledger or a parent ledger of the ledger the NFT 302 is recorded on. The pointer bit field may point directly or indirectly to an object or objects recorded on another ledger. For example, an indirect pointer might comprise a name or other identifier of the target location. The name may then be used as a query for a name service which translates the name to the location of the target object. Thus, the indirect pointer does not necessarily point directly to the object location, but rather can be used as a proxy to obtain the direct pointer or location.

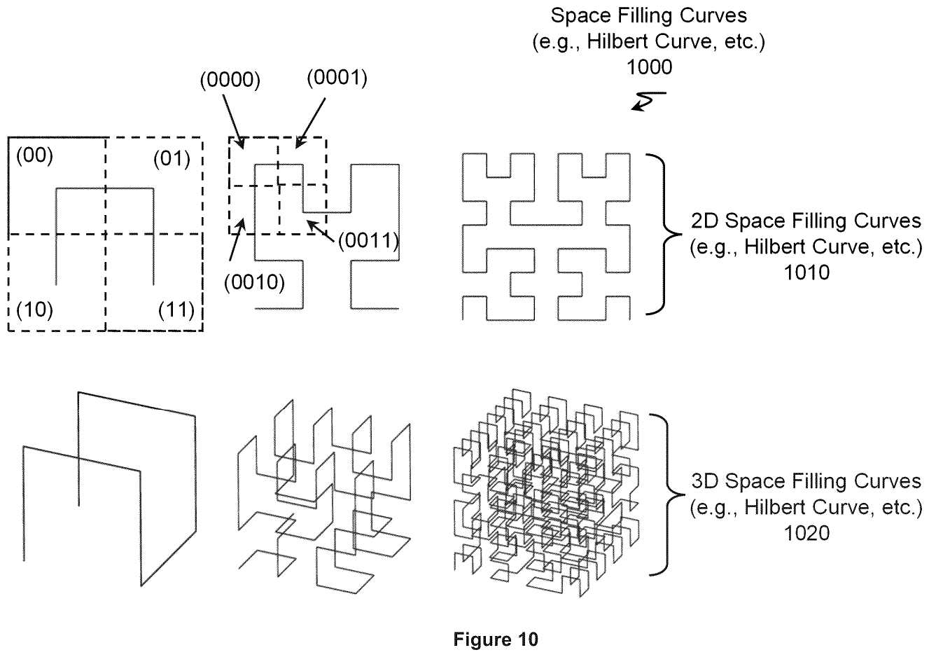

In certain embodiments, the address 404 of the NFT includes geolocation information (e.g., a physical address, identifier of the physical address, etc.). The geolocation information may indicate a location corresponding to the NFT. For example, the geolocation information may be represented by the NFT. The geolocation information may correspond to a ledger in the hierarchy of ledgers and at the index. The geolocation information may include an index identifying a ledger (e.g., a child ledger). In certain embodiments, the identifier of the ledger includes at least 64 bits. In certain embodiments, the identifier of the ledger includes an S2 cell identifier, which may typically be a 64-bit identifier although other practical sizes are also contemplated. Other cell identifiers derived from space filling curves may also be used (e.g., Hilbert curves, Z-order curves, FASS curves, Peano curves, Morton curves, etc.) as discussed with respect to FIG. 10. Such an approach is considered advantageous because space filling curves provide for generating a single identifier for a location which increases the speed of lookup and access. Still, multi-valued identifiers are also contemplated.

Consider the following example embodiment of NFT 302 used to represent a real-world parking space. The NFT may be a geolocation NFT and therefore correspond to a location. The NFT may be recorded on a first ledger that corresponds to a first location, such as a parking lot, and the NFT may correspond to (i.e., represent) a second location that is a subset of and/or included in the first location, such as a parking space within the parking lot. The first ledger the NFT is recorded on may include any number of NFTs. Any number of the NFTs recorded on the first ledger may correspond to sub locations of the location (e.g., parking spaces). The NFT may include an identifier of the second ledger. The NFT may include an index that indicates an index of the second ledger. The index of the NFT may be useful to determine or identify the second ledger and/or a node of the second ledger that transaction data may be transmitted to. The second NFT may include second information representing at least state information of the second ledger. The state information may indicate when a value has changed on the second ledger, a transaction has been added to the second ledger, etc.

Consider the following second example embodiment of NFT 302 with respect to postal codes. The NFT may be a geolocation NFT and therefore correspond to a location. The NFT may be recorded on a first ledger that corresponds to a first location, such as a postal code, and the NFT may correspond to a second location that includes the first location, such as a state that includes the postal code. The first ledger the NFT is recorded on may include any number of NFTs. Any number of the NFTs recorded on the first ledger may correspond to parent locations of the location. The NFT may include an index identifying the second ledger. The NFT may include an index that indicates an index of the second ledger.

Consider the following third example embodiment of NFT 302 relating to network domains. NFT 302 may correspond to a part of a URL. For example, the NFT may correspond to a ledger that records transactions related to a subdomain, a second-level domain (SDL), a top level domain (TLD), or a page path. The ledger the NFT is stored on may correspond to transactions related to a protocol, a subdomain, a SLD, or a TLD, respectively. As can be seen by this third example, the disclosed inventive techniques may be used in non-geolocation use cases.

In certain embodiments, a number of ledgers in a ledger hierarchy may correspond to a first category and a second number of ledgers in a ledger hierarchy may correspond to a second category. For example, a first ledger may include an NFT that corresponds to a location ledger and a second NFT that corresponds to a URL ledger. Accordingly, the first ledger may be included in a technique to determine an index of different categories of ledgers as well as cross reference ledgers in different categories. Thus, a location ledger may have a digital token representing or pointing to a URL ledger and/or the URL ledger may have a different digital token representing a pointing to a location ledger.

In yet another embodiment, a number of ledgers in a ledger hierarchy may correspond to a first category and a second number of ledgers in a ledger hierarchy may correspond to a second category. For example, the ledgers associated with locations may be used to drill down to a fine grained location, such as by determining a state ledger from an NFT of a country ledger, then determining a city ledger from an NFT of the state ledger, then determining a school ledger from the city ledger, and so on. Then NFTs on the city ledger may correspond to URLs owned by a school, and the school ledger can be used to determine an SDL ledger, and the SDL ledger can be used to determine a TLD ledger. Such an approach is considered advantageous because use of crosslinking ledgers via NFTs provides for faster indexing and retrieval of ledger information compared to techniques including brute force review of ledger block data. The capability for a system to perform faster indexing can reduce the computational strain on the system, allowing for less computation resources to be included in the system and/or freeing up computational resources to be used for other system processes. Since the number of ledgers available for public and/or private use will continue to grow, the disclosed crosslinking approaches provide for smooth growth in digital ledger technologies because users will be able easily to find and access target ledgers from another ledger.

The processing depicted in flow diagrams 500 and 600, and any other FIGS. may be implemented in software (e.g., code, instructions, program, etc.) executed by one or more processing units (e.g., processors, cores, etc.) of the respective systems, using hardware, or combinations thereof. The software may be stored on a non-transitory storage medium (e.g., on a memory device). The software may be stored on at least one non-transitory computer readable memory storing a plurality of notarized ledgers (e.g., where each notarized ledger is indexed by at least one corresponding geographic location index or context index) and storing software instructions. The method presented in flow diagrams 500 and 600, and other FIGS. and described herein are intended to be illustrative and non-limiting. Although flow diagrams 500 and 600, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in flow diagrams 500 and 600, and other FIGS., may include a greater number or a lesser number of steps than those depicted in the respective FIGS.

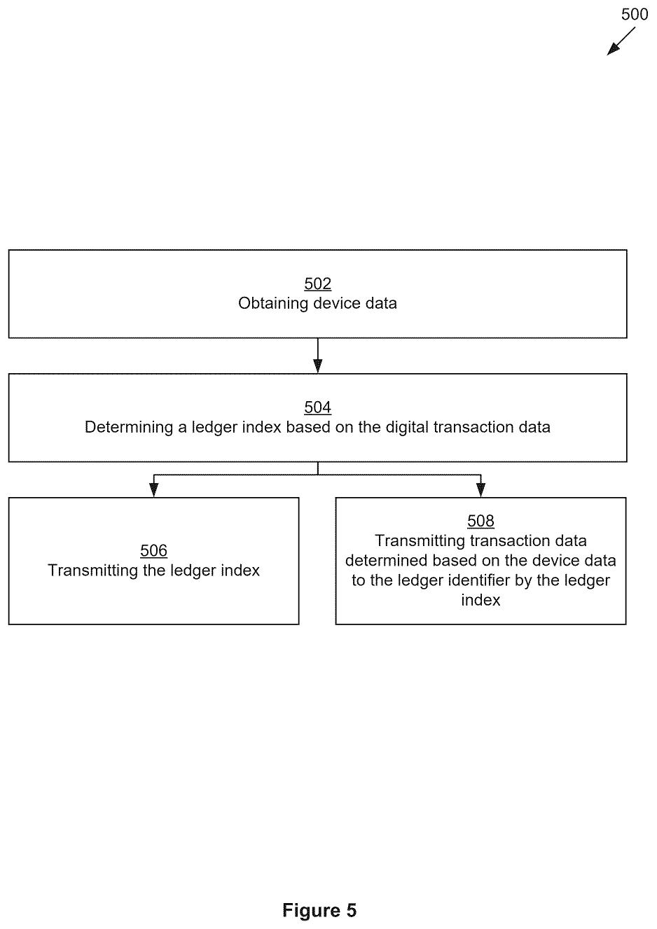

FIG. 5 shows a flow diagram 500 illustrating a method utilized by a computer-based transaction management system according to certain embodiments, in accordance with the present disclosure. Flow diagram 500 may be performed by a computer-based transaction management system (e.g., transaction management system 120 described with respect to system 100). As mentioned above, the transaction management system may be implemented by leveraging a smart contract of a ledger or may be implemented using a computer system separate from a ledger or ledger node.

At 502, the transaction management system may obtain device data from one or more devices (e.g., cell phone, electronic transaction card, computer, set top box, appliance, vehicle, etc.). The device data may be digital data. The device data may be the device data 116 described above, for example. The device data may be obtained from a device (e.g., device 112 described above). The device data may include transaction data and/or be used to determine context or transaction data to be recorded on one or more ledgers. The ledgers may be included in a hierarchy of ledgers (e.g., tree, Trie, B-tree, etc.) or other arrangement of ledgers (e.g., organized as graphs, organized as a network, organized as linked lists, organized as a queue, organized a stack, etc.).

At 504, the transaction management system may determine a ledger index (e.g., a ledger identifier, etc.). The ledger index may be part of a schema indexing the arrangement of ledgers of ledgers. As described above, the ledger index may be determined as a function of the device data (e.g., using a hash function, a lookup, etc.), possibly based on a context derived from the device data. In certain embodiments, the ledger index includes an address of a ledger, an address of a smart contract, or a node of a ledger. In certain embodiments, the ledger index can be used with a lookup table to determine an address of the ledger corresponding to the ledger index. In certain embodiments, the transaction management system determines more than one index of a ledger based on device data. For example, the device data may include data to be recorded on more than one ledger, whether the ledgers are in a parent-child relationship or otherwise linked with one another or not. See also the discussion regarding ledger-based application stacks as discussed with respect to FIG. 11.

In certain embodiments, the transaction management system may determine transaction data (e.g., transaction data 114 described above) based on the device data. In certain embodiments, the transaction data may also be based on the determined ledger index. The transaction data may be transmitted at step 508.

At 506, the transaction management system may transmit the ledger index and/or ledger data corresponding to the ledger index determined at step 504. The ledger index and/or ledger data corresponding to the ledger index may be transmitted to the device that the device data was received from so that the device may transmit the device data or different device data to an entry point (e.g., node, smart contract, ledger, application layer, etc.) for the ledger corresponding to the ledger index. In such embodiments, the transaction management system may serve as a lookup system (e.g., a look up table, a hash table, a tree, a trie, bitmap indexing, inverted indexing, grid indexing, a KD-tree, Knn search, etc.) that the device can use to determine where to record a transaction. One should appreciate that a search for a ledger having a corresponding index may not find a ledger having the exact matching index. Thus, in some cases, it is possible to return a ledger having an index that is near or nearest to the index query.

Such approaches can be considered advantageous when employing context-based indexes for ledgers. For example, consider a scenario where a person wishes to conduct an asset transaction via a cell phone using a local ledger that is bound to a nearby location. The cell phone's location could be used to determine a corresponding S2 cell identifier (i.e., an index) to be used as a query to find the local ledger. However, the local ledger's S2 index might be slightly different than, but still close to, the cell phone's S2 identifier. Thus, when the cell phone's S2 identifier is used to query the ledger search service, the search service may simply return the local ledger because its S2 cell index is the closest or best match given the search query and the local ledgers context selection criteria. This can be achieved via a nearest neighbor search (i.e., Knn search) and the S2 cell property that identifiers near the same location may be near each other in the S2identifier address space.

At 508, the transaction management system may transmit the transaction data to a ledger, a smart contract, or a node of the ledger, identified by the ledger index determined at step 504. The transaction data may include data to be included in a transaction to be recorded on the ledger and/or a child of the ledger identified by the ledger index. For example, the data may be compiled into a transaction block for the ledger or stored off ledger.

In certain embodiments, the transaction data is transmitted to the ledger identified by the ledger index and the transaction data is used to determine an NFT that corresponds to at least a portion of the transaction data, the NFT may correspond to (e.g., point to) a child ledger of the ledger identified by the index. Transaction data may then be recorded on the ledger identified by the ledger index and/or the child ledger corresponding to the NFT. Thus, the NFT may represent the child ledger or could represent one or more assets related to the identified ledger. Example assets may include real estate, stock, currency, commodities, futures, virtual goods or services, real-world assets or services, a house or building, vehicles, game assets, digital collectibles, coupons, patents, rights, or other types of assets that are tangible or intangible.

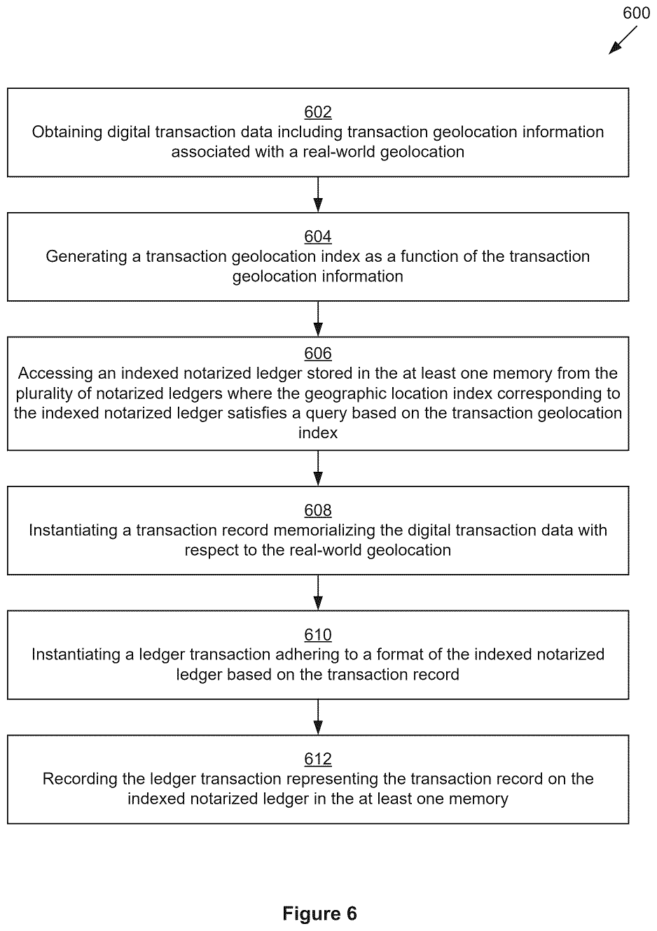

FIG. 6 shows a flow diagram 600 illustrating a method utilized by a computer-based data indexing system according to certain embodiments, in accordance with the present disclosure. While the example in FIG. 6 illustrates using location as an index, it should be appreciated that other context-based attributes may be used as an index as well. The computer-based data indexing system may include the system 100, or a portion thereof, described above.

At 602, digital transaction data may be obtained, possibly from a mobile device whose user may wish to conduct a transaction relating to at least one real-world asset. The digital transaction data may be obtained from a device (e.g., device 112 described above). The digital transaction data may be included in device data (e.g., device data 116 described above) transmitted from the device to a transaction management system (e.g., transaction management system 120 described above).

In certain embodiments, the digital transaction data includes geolocation information associated with a real-world geolocation, possibly part of a large context. The geolocation information may be associated with a real-world geolocation of the device, of a sender wallet address (e.g., based on a preconfigured association with the geolocation), an asset location, a receiver wallet address (e.g., based on a preconfigured association with the geolocation), or other location related to the transaction or asset. In certain embodiments, the digital transaction data includes geolocation information associated with a virtual-world geolocation, such as a server, a realm, a virtual coordinate position, location of an asset, location of a ledger node, etc. In certain embodiments, the digital transaction data includes other location data such as a memory location, or a file path location, etc.

At 604, an index may be generated based on the contextual data available from the transaction data and/or device data. The index may be generated by a transaction management system (e.g., transaction management system 120 described above). The index may be generated as a function of the device data. The index may correspond to a ledger. In certain embodiments, the index corresponds to more than one ledger, a layer in a ledger-based application stack, a smart contract, or other elements related to the one or more ledgers. In certain embodiments, the index is determined based on the geolocation information included in the device data and may be referred to as a transaction geolocation index. The transaction geolocation index may identify a ledger that corresponds to the geolocation information. For example, within an S2 geometry context, the index may be an S2 cell identifier derived from the device data. In some embodiments, a GPS coordinate (e.g., latitude, longitude, altitude, etc.) may be used to derive a corresponding S2 cell identifier. Thus, the S2 cell identifier may be considered the index or a portion of the index.

At 606, an indexed notarized ledger may be accessed. The ledger accessed may correspond to the index generated at step 604. The ledger may be stored in at least one memory of a plurality of ledgers. The plurality of ledgers may comprise a ledger hierarchy (e.g., ledger hierarchy 124 described above) or other arraignment of ledgers. The ledger hierarchy may include at least one parent ledger and one or more child ledgers of the parent ledger.

In certain embodiments, the index generated at step 604 directly indicates a ledger to access (e.g., a ledger satisfying a query based on the index generated at step 604). An example of the direct indication may include indicating a node address of the ledger to access, a smart contract to access, an API of a ledger-based application stack to access, a layer of an application stack to access, or other ledger entry point to access. In certain embodiments, the index generated at step 604 indirectly indicates the ledger to access, an application layer of a target ledger, or a portion of a target ledger. An example of the indirect indication may include indicating an NFT on a ledger, and the NFT includes information identifying another ledger to record a transaction, transmit the transaction data to, and/or transmit the device data to. The transaction data and/or device data may be used by the ledger indicated by the NFT to conduct a transaction and/or generate an index of another ledger (e.g., similar to steps 602-606).

At 608, a transaction record may be instantiated. The transaction record may memorialize the device data and/or the transaction data received from the transaction management system. The transaction record may memorialize transactions with respect to at least a portion of the device data (e.g., a real-world location, a virtual location, a device, organizational structure, a legal system, a corporate governance, project management, a file system, an educational system, software, products, information technology infrastructure, military structure, government structure, supply chain management, real-world asset, and/or a document, etc.). The transaction record may be integrated in a block with other transaction records where the block may then be recorded on the target ledger.

At 610 a ledger transaction may be instantiated as a data object in the system's computer readable memory. The ledger transaction may be instantiated according to a format of the indexed notarized ledger accessed at step 606 and/or according to the transaction record recorded on the indexed notarized ledger. The ledger transaction may include at least a portion of the transaction data and/or the device data. In some embodiments, the ledger transaction or transaction blocks may be instantiated by an application layer function as a layer 2 on top of the layer 1 target ledger.

At 612, the ledger transaction instantiated at step 610 may be recorded on the indexed notarized ledger. In certain embodiments, as described herein, the transaction record may be recorded off ledger and data pointing to the transaction record may be recorded on the indexed notarized ledger.

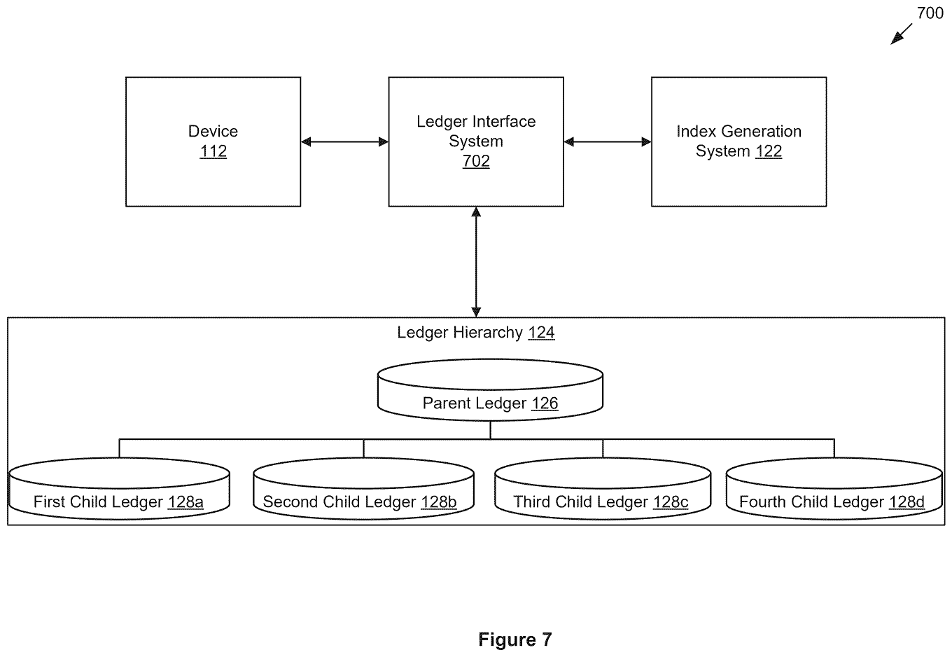

FIG. 7 illustrates a block diagram of a system 700 for viewing blockchain, or other notarized ledger, data according to certain embodiments, in accordance with the present disclosure. The system 700 may include a device 112 (e.g., device 112 described above), a ledger interface system 702, an index generation system 122 (index generation system 122 described above), and a ledger hierarchy 124 (e.g., the ledger hierarchy 124 described above). In certain embodiments, the ledger interface system 702 is local to the device 112 (e.g., executing on the device 112), possibly in form of an application, a cell phone app, a website, or other interface.

The device 112 may communicate with the ledger interface system 702 (e.g., using a network connection such as network 118 described above, cell phone network, WAN, LAN, etc.). The ledger interface system 702 may be configured to perform ledger browsing functions. The ledger interface system 702 may be configured to read ledgers from the ledger hierarchy 124. In certain embodiments, the ledger interface system 702 can be used to record transactions on a ledger included in the ledger hierarchy 124.

In certain embodiments the ledger interface system 702 may transmit information included on parent ledger 126. The parent ledger information may include transactions, smart contracts, digital tokens, and/or NFTs, etc. The ledger interface system 702 may transmit the parent ledger 126 information to the device 112 and the device 112 may present the information (e.g., using a user interface). In certain embodiments, the information from the parent ledger 126 includes as least a portion of the information represented on one or more child ledgers (e.g., first child ledger 128a, second child ledger 128b, third child ledger 128c, fourth child ledger 128d, etc.). In certain embodiments, the information from the parent ledger 126 includes a summary (e.g., state information, name, context information, etc.) of the information included on the child ledger 128. The information from the parent ledger 126 may include data included in an NFT (e.g., an address 404, an identifier 402, an index 406, second information 408, etc.). The

The ledger interface system 702 may receive an indication from the device 112 to present information included on a child ledger 128. For example, a user interface of the device 112 (e.g., a mouse, touch screen, etc.) may receive an indication that information on the first child ledger 128a should be presented on a second user interface (e.g., a display) of the device 112. The ledger interface system 702 may determine an index corresponding with the first child ledger 128a (e.g., based on data included in an NFT, based on location data of the device 112, based on input received from an interface of the device 112, context data, etc.) and query the first child ledger 128a based on the index. In some scenarios parent ledger 126 may operate as a name service for child ledgers 128a through 128d (child ledgers 128). For example, parent ledger 126 may have NFTs recorded on it where each NFT points to or otherwise references child ledgers 128. In such cases, child ledger information may be obtained through the pointers provided by the corresponding NFTs, or other digital tokens.

Determining an index of the first child ledger 128a may be performed using the index generation system 122. The index generation system 122 may generate an index based on one or more contexts derived from the device data. The index generation system 122 may generate an index based on a search criteria received from the device 112. The search criteria may include a location as part of the context data.

The index of the first child ledger 128a may enable the ledger interface system 702 to read information recorded on the first child ledger 128a and transmit the information recorded on the first child ledger 128a to the device 112 for presentation. The information may be presented and interacted with in a similar manner as described above with respect to presenting information recorded on the parent ledger 126.

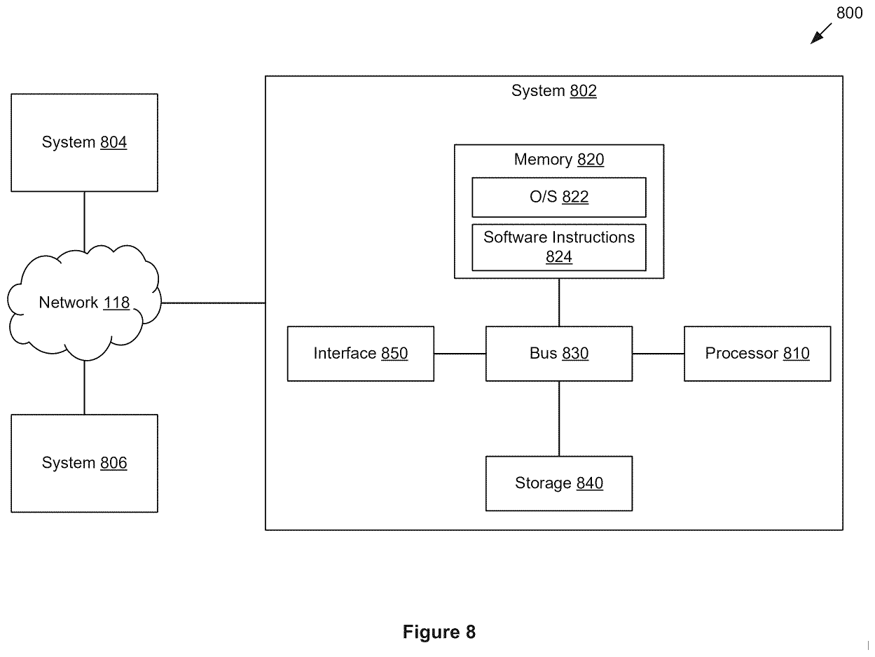

FIG. 8 is a block diagram of a computer system 800, possibly a distributed computing system, usable to implement embodiments of the present disclosure. Various aspects and functions described herein may be implemented as hardware, software executing on hardware, or a combination of hardware and software executing on one or more computer systems. Aspects in accordance with the present disclosure may be located on a single computer system or may be distributed among one or more computer systems connected to one or more communication networks, possibly in a cloud-based system.

For example, various aspects and functions may be distributed among one or more computer systems configured to provide a service to one or more client computers, or to perform an overall task as part of a distributed system. Additionally, aspects may be performed on a client-server system, peer-to-peer system, cloud system, or multi-tier system that includes components distributed among one or more server systems that perform various functions.

The distributed computer system 800 of FIG. 8 includes three computer systems 802, 804, and 806 (although a different number of computer systems is possible). The computer systems 802, 804, and 806 can be operated by different entities and/or can be computing nodes of a notarized ledger system (e.g., a blockchain network, a hashgraph network, holochain, etc.). Each computing node may represent an entry point to the corresponding notarized ledger. As shown, the computer systems 802, 804, and 806 are interconnected by, and may exchange data through, a communication network 118 (e.g., network 119 described with respect to FIG. 1). The network 118 may include any communication network through which computer systems may exchange data. To exchange data via the network 118, the computer systems 802, 804, and 806 and the network 118 may use various methods, protocols, and standards including, among others, token ring, Ethernet, Wireless Ethernet, Bluetooth, NFC, TCP/IP, UDP, HTTP, FTP, SNMP, SMS, MMS, SS7, JSON, TOON, XML, REST, SOAP, CORBA IIOP, RMI, DCOM, and Web Services. The communication network 118 may further employ one or more mobile access technologies including 2nd (2G), 3rd (3G), 4th (4G), 5th (5G) generation radio access for cellular systems, WLAN, Wireless Router (WR) mesh, and other communication technologies. Access technologies such as 2G, 3G, 4G, LTE, and future access networks may enable wide area coverage for mobile devices.

Computer systems 802, 804, and 806 may include clients and servers. In various embodiments, to ensure data transfer is secure, the computer systems 802, 804, and 806 may transmit data via the network 118 using a variety of security measures including TSL, SSL, or VPN, among other security techniques.

Various aspects and functions may be implemented as specialized hardware or software executing in one or more computer systems including the computer system 802 shown in FIG. 8. As depicted, the computer system 802 includes a processor 810, a memory 820, a bus 830, an interface 850, and a storage system 840. The processor 810, which may include one or more microprocessors or other types of controllers, can perform a series of instructions that manipulate data. As shown, the processor 810 is connected to other system placements, including a memory 820, by the bus 830.

The memory 820 may be used for storing programs and data during operation of the computer system 802. Memory 820 may include at least a storage area network (SAN), a network area storage (NAS) system, a distributed storage system, a cloud-base storage system, a file system, a distributed file system, object based storage (e.g., CEPH, etc.) and/or a torrent.

The memory 820 may be a relatively high performance, volatile, random access memory such as a dynamic random access memory (DRAM) or static memory (SRAM). However, the memory 820 may include any device or combination of devices (e.g., multiple distinct memories) for storing data, such as a disk drive or other non-volatile storage device, such as flash memory or phase-change memory (PCM). Various embodiments in accord with the present disclosure can organize the memory 820 into particularized and, in some cases, unique structures to perform the aspects and functions disclosed herein. The memory 820 may store program code of an operating system 822 and software instructions 824 for a TMP.

Components of the computer system 802 may be coupled by an interconnection element such as the bus 830. The bus 830 may include one or more physical busses (for example, busses between components that are integrated within a same machine) and may include any communication coupling between system placements including specialized or standard computing bus technologies such as IDE, SCSI, PCI, USB, and InfiniBand. Thus, the bus 830 enables communications (for example, data and instructions) to be exchanged between system components of the computer system 802.

Computer system 802 also includes one or more interfaces 850 such as input devices, output devices and combination input/output devices. The interface 850 may receive input, provide output, or both. For example, output devices may render information for external presentation. Input devices may accept information from external sources. Examples of interface devices include, among others, sensors, keyboards, mouse devices, trackballs, microphones, touch screens, printing devices, display screens, speakers, network interface cards, etc. The interface 850 allow the computer system 802 to exchange information and communicate with external entities, such as users and other systems.

Storage system 840 may include a computer-readable and computer-writeable nonvolatile storage medium in which instructions are stored that define a program to be executed by the processor. The storage system 840 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A non-transitory medium that can be used with various embodiments may include, for example, optical disk, magnetic disk, or flash memory, among others. In operation, the processor 810 or some other controller may cause data to be read from the nonvolatile recording medium into another memory, such as the memory 820, that allows for faster access to the information by the processor 810 than does the storage medium included in the storage system 840. The memory may be located in the storage system 840 or in the memory 820. The processor 810 may manipulate the data within the memory 820, and then copy the data to the medium associated with the storage system 840 after processing is completed. A variety of components may manage data movement between the medium and the memory 820, and the disclosure is not limited thereto.

Further, embodiments of the present disclosure are not limited to a particular memory system or storage system. Although the computer system 802 is shown by way of example as one type of computer system upon which various aspects and functions in accord with the present disclosure may be practiced, aspects of the disclosure are not limited to being implemented on the computer system. Various aspects and functions in accord with the present disclosure may be practiced on one or more computers having different architectures or components than that shown in FIG. 8. For instance, the computer system 802 may include specially-programmed, special-purpose hardware, such as for example, an application-specific integrated circuit (ASIC), FPGS, or PLA tailored to perform a particular operation disclosed herein. Another embodiment may perform the same function using several general-purpose computing devices running the operating system 822.

The operating system 822 may manage at least a portion of the hardware placements included in computer system 802. A processor or controller, such as processor 810, may execute an operating system which may be, among others, a Windows-based operating system (for example, Windows NT, Windows 2000/ME, Windows XP, Windows 7, Windows 8, Windows 10, Windows 100, or Windows Vista) available from the Microsoft Corporation, a MAC OS System X operating system available from Apple Computer, one of many Linux-based operating system distributions (for example, the Enterprise Linux operating system available from Red Hat Inc., Ubuntu, etc.), a Solaris operating system available from Sun Microsystems, or a UNIX operating systems available from various sources. Many other operating systems may be used, and embodiments are not limited to any particular operating system.

In various embodiments, processor 810 and operating system 822 together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present disclosure may be implemented using an object-oriented programming language, such as Python, JAVA, C++, C# (C-Sharp), Solidity, or Vyper, among others. Other object-oriented programming languages may also be used. Alternatively, procedural, scripting, or logical programming languages may be used.

Additionally, various functions in accord with aspects of the present disclosure may be implemented in a non-programmed environment (for example, documents created in HTML, XML or other format that, when viewed in a window of a browser program, render aspects of a graphical-user interface or perform other functions). Further, various embodiments of the present disclosure may be implemented as programmed or non-programmed placements, or any combination thereof.

Although many embodiments herein mainly describe examples with respect to location-based hierarchies, other embodiments described make clear that embodiments are not limited to hierarchies or location per se. The methods and systems described in the present disclosure support multiple use cases. Below are some further illustrative non-limiting use cases and examples.

In one use case, location based ledgers may be used to track crop rotations on farms. Crop data may be recorded on a ledger corresponding to a portion of a field the crops are planted on. The portions of a field may be child ledgers of a field ledger in a set of field ledgers. The field ledger may be the child of a county ledger in a set of county ledgers. The ledgers may track crop rotations at varying levels of specificity. For example, the field ledger may track the types of crops (e.g., corn, soybean, etc.) included in the field over time, while the ledgers for portions of the field may track fine grain details about the plants, such as when they were planted, watered, fertilized, etc. Further, ledgers may be instantiated for specific contexts, weather conditions or seasons for example. Thus, child ledgers may be differentiated based on locations and/or other attributes such as season or other contextual information. In some scenarios, a child ledger representing a field might itself have child ledgers representing seasons.

In an example use case, when a wallet address associated with a device is within a physical area corresponding to a parent ledger for an amount of time, the wallet address may obtain cryptocurrency recorded on the parent ledger as a function of the time the device is within the physical area. In certain embodiments, an NFT is minted when the device enters the physical area associated with the parent ledger and the NFT may be burned when the device leaves (e.g., within 30 seconds after, one day after, etc.) the physical area associated with the parent ledger. In certain embodiments, when transaction data is recorded on a ledger, a smart contract on the ledger or a system monitoring ledger transactions may cause a notification to be transmitted. For example, the notification may be capable of indicating when a device has entered a physical area or left a physical area. The notifications may be capable of determining a direction of travel based on a location left and a location entered and/or a time spent at a location. In this example, both location and time are used as a context for permitting or restricting ledger access or executing ledger operations. Such an approach can be considered useful for management aspects of Know Your Customer (KYC) and/or Anti-Money Laundering (AML), among other security issues.

In certain embodiments, a first wallet address associated with a device and a first ledger may not be enabled to record a transaction to the first ledger or read a transaction from the first ledger if a second ledger associated with a second wallet address associated with the device was not first recorded to, or if an NFT is not in the second wallet (e.g., the NFT may act as an access control mechanism). Thus, NFTs may provide gating functionality among ledgers. For example, a user interacting with an asset exchange system might only be permitted to access the target asset exchange ledger-based application when the user owns a corresponding access granting NFT on a primary ledger and that points to the asset exchange ledger.

In certain embodiments, more than one ledger may correspond to a same physical area. Determining which ledger to record a transaction on may be determined based on device data and an index generation function. For example, a first ledger may represent transactions recorded by a pretzel shop in a shopping mall. The shopping mall may be represented by a second ledger. A third ledger may represent transactions recorded by an ice cream shop. The ice cream shop may have replaced the pretzel shop at the same location in the shopping mall and therefore the third ledger may have been generated after the first ledger was archived to maintain for pretzel shop information for record keeping purposes. The first ledger may have a first owner and the third ledger may have a second owner. The ownership of the first ledger and third ledger may be identified or referenced by an NFT on the second ledger (i.e., the mall ledger). The capability to record transactions on and/or read transactions from the third ledger may be granted to the owner of the NFT and/or an owner of the second ledger.

The above disclosed inventive techniques have mainly focused on using location or locations as an index for one or more ledgers. As alluded to above, a location attribute may be considered one dimension of a larger context space that may be relevant to the user, device, location, or other aspects of a transaction. Thus, one should appreciate the inventive subject matter is not restricted to location indexed notarized ledgers, but also extends to larger more complex indexing systems and is considered to include creating, using, or otherwise managing notarized ledger indexing systems leveraging nearly any type of index. The following discussion expands techniques and uses cases of context-based notarized ledger indexing systems.

Turning to FIG. 9, FIG. 9 provides an illustration of N-dimensional context space 900. While context space 900 is presented as a 3D context space for practical illustrative reasons for this document, it should be appreciated that a context space 900 can be generalized to any number of practical dimensions (e.g., location, time, temperature, demographics, psychographics, weather, actions, etc.). In the example shown, context space 900 has a location dimension represented by dimension 910B, a time-based dimension 910A, through a weather based dimension 910N indicating dimensions 910A through 910N include any number of dimensions. Each of dimension 910A through 910N may be represented using discrete units (e.g., date, S2 cells, etc.) or continuous units (e.g., time, temperature, etc.). In some embodiments, context space 900 can be implemented as a defined namespace comprising a set of attributes representing the dimensions where the attributes can take on values representing the coordinates within context space 900. For example, a location attribute might include values from a set of one or more S2 cell identifiers while a weather attribute might include words, terms, or identifiers representing weather conditions (e.g., “SUNNY”, “CLOUDY”, “HOT”, etc.). While these examples provide high level names for dimensions in a namespace, the namespace can be organized as a hierarchy. For example, weather might include “weather.temp” where the attribute-pair of weather might be “weather: HOT” and the subcategory might be “weather. temp: 90 degrees F.” This example also illustrates that each dimension, subdimension, or other subcategory may also include metadata possibly including measurement unit definitions. Other organizational structures of context space 900 are also possible including hierarchical structures, trees, defined ontologies, graphs, relational structures, or other structures.

Returning to the concept of indexed ledgers, in some embodiments ledgers may be tagged with attributes and corresponding values that can be used to retrieve target ledgers. Thus, a ledger might only be relevant at one or more geo-locations (e.g., zip code, collection of S2cells, geofence, etc.) AND (logical AND) when the weather takes on a specific condition (e.g., SUNNY, HOT, CLOUDY, FIRE, etc.). Such a ledger may be retrieved from a ledger retrieval system (see FIG. 1 system 100) by submitting a query to the system where the query is constructed based on the dimensional features of context space 900 (e.g., attribute-value pairs, keywords, tags, values, etc.). In such cases, the query may leverage multiple values or terms to find the target ledgers. In this sense, the target ledgers can be considered to have a set of indices or have a multi-valued set of indices by which the target ledger may be looked up or otherwise found.

Context space 900 is also illustrated as having one or more defined contexts: context 920A and context 920B. While only two contexts are presented, any practical number of contexts may be defined. Contexts 920A and 920B illustrate that a volume of space within context space 900 can be defined to be a single context. For example, context 920A might represent an alternative trading system (ATS) operating at a specific location and at a specified time, among other dimensional requirements. Context 920B might represent a gaming context at a different location or time. These contexts might become “active” when a device or user has a set of attributes satisfying the corresponding context's definition. This can be achieved by monitoring attributes of the user or device, possibly from sensor data collecting a digital representation of the scene or environment, when their attributes fall within the same namespace used to define context space 900. In these examples, each context may have a unique identifier (e.g., GUID, UUID, name, hash ID, etc.), which then may be used to retrieve one or more corresponding target ledgers. In this scenario, the target ledgers may be indexed by a single value corresponding to the context identifier. One should appreciate that a context still might point to more than one ledger. For example, context 920A might point to a ledger application stack having layers bound together to form an ATS for a specified location (see discussion with respect to FIG. 11 for example).

While context space 900 aids in illustrating how a multi-dimensional context space may permit access to a context-based ledger, one should appreciate there are additional features or functionalities that arise from use of context space 900. For example, a context may restrict access to a target ledger. Consider the ATS example discussed above. While a user device might satisfy the location and time requirements for accessing an ATS application stack, other attributes might restrict access to the ATS application stack. More specifically, as a real-world example, some users may be restricted based on citizenship due to jurisdictional regulations. Thus, the context definition may include a set of criteria (e.g., logical conditions, compound conditions, restrictions, etc.) that must be satisfied to gain access. A possible ATS context could be defined as {location==“EUROPE” AND time==“WEEKDAY” AND NOT(Citizenship==“American” OR “Canadian”)}, note use of logical operators AND and OR. When all conditions are true, access may be granted. Other logical operators may also be used possibly including NAND, XOR, IF-THEN-ELSE, NOR, XNOR, Intersection, Union, or other logical operations or conditionals. To be clear, when the context definition requirements have been satisfied, the context's corresponding ledger identifier(s) may be accessed.

One aspect of the inventive subject matter is creating an indexing system based on N-dimensional context space 900, where a context may be defined based on a single unit of volume in the space. The single unit of volume, for the purposes of this description, is called a “Noxel.” Where a voxel can be considered a 3D equivalent to a 2D pixel, a noxel can be considered an N-dimensional unit of volume. One should appreciate that noxels may have regular shapes, irregular shapes, varied sizes, varied shapes, varied dimensions, or characteristics depending on context space 900 or on how contexts 920A through 920B have been defined. Thus, noxels in one context definition may be different that noxels in a different context definition. In some embodiments, a context, context 920A through 920B for example, may comprise a set of one or more noxels, possibly neighboring or contiguous noxels in context space 900. One should appreciate that a single noxel may be represented as at least one point, possibly the center point of the noxel, in context space 900. The point may be represented by a collection or set of attribute-value pairs where the attributes represent one of dimensions 910A through 910N and the value represents the position along the dimensions.

Each noxel in context space 900 may be assigned an identifier, which can then be used as an index to a notarized ledger that corresponds to the noxel. Such an approach is similar to assigning an S2 identifier to a notarized ledger through which the notarized ledger may be accessed, retrieved, or otherwise managed. Alternatively, a context formed from a set of noxels may have a single identifier, possibly selected from the set of corresponding noxel identifiers, which may be used as an index for the context's notarized ledger. Yet further, the context's notarized ledger may be indexed by multiple identifiers, each noxel's identifier for noxels in the context for example.

Context space 900 may be partitioned in many different ways. In some embodiments, as alluded to above, each dimension may be quantized in a regular fashion; by the same units of time (e.g., minutes, hours, days, weeks, months, year, etc.), by the same units of location (e.g., S2 cells, zip codes, longitude or latitude degrees or portions thereof, etc.), or other regular units corresponding to the nature of dimensions 910A through 910N. Such an approach may provide for computationally easy assignment of identifiers as discussed above. However, it is also possible that context space 900 may be partitioned into noxels in an irregular fashion where each noxel may have arbitrary boundaries, possible through manual assignment. Still further, the irregular noxels may be assigned identifiers via other techniques, possibly based on a hash value of the corresponding context definition (e.g., name, defining characteristics, attribute-value pairs, etc.), based on a traversal of the space, or other techniques as described further below. Ideally, as with S2 cells, contexts that are similar to each other would preferably have similar identifiers for fast Knn retrieval.

In some embodiments, noxel identifiers may be assigned through use of a space filling curve as illustrated in FIG. 10. FIG. 10, shows how a Hilbert curve may be used as 2D space filling curves 1010 to address each point in a 2D space, the 2D analog of context space 900. Each vertex or point (e.g., corner, point along segment line, etc.) of curves 1010 may be considered to represent the center of 2D cell (i.e., 2D noxel). For example, the far left curve of curves 1010 uniquely identifies four cells. The middle curve of curves 1010 uniquely identifies 16 cells. The far right curve of curves 1010 uniquely identifies 64 cells. As can be seen, curves 1010 may be used to generate cells of various levels of granularity, possibly in a hierarchical fashion.

One should appreciate there is no requirement that each cell be further subdivided. For example, one large cell may be sufficient for practical purposes (say a large section of ocean with little transaction traffic) while other large cells may need to be further subdivided (say a city like Los Angles having high density of transaction traffic). Further, assignment of the cell identifiers may also follow the hierarchical nature of curves 1010. Consider the left most curve of curves 1010, there are four cells represented by the dash line, each may be assigned a two-bit ID: upper left (00), upper right (01), lower right (11), lower left (10). It should be noted that bits are used in this example; however, other IDs may be used (e.g., A, B, C, D, 0, 1, 2, 3, etc.). Bits may be more memory efficient. The middle curve of curves 1010 represents the next finer level of granularity showing how the upper left cell, ID==(00), has been further subdivided into four new cells. These new cells, following the hierarchical arrangement, will have a prefix identifier of corresponding to the parent cell and then child identifiers: upper left child cell (0000), upper right child cell (0001), lower right child cell (0011), and lower left child cell (0010). Through these assignment structure, cells having similar ID will be close to each other. This system of assignment continues to any desired level of granularity. In this case, four bits are used to represent the IDs; however, a hierarchical ID may also be used leveraging other schemes (e.g., A. A, A. B, A. C, A. D; 0.0, 0.1, 0.2, 0.3; etc.). An astute reader will appreciate the similarity to S2 cell geometry.

Space filling curves 1020 illustrates that space filling curves may be generalized to any number of practical dimensions, three dimensions as in the case of space filling curves 1020. In view that space filling curves 1020 fill higher dimensions, the noxels will require additional bits to identify the noxels. In the example, each noxel on the left curve of curves 1020 will require at least three bits to represent the eight noxels in three dimensions: (000), (001), (010), (011), (100), (101), (110), and (111). Again, other naming or identification schemes may be used to, preferably uniquely, identify the noxels. Thus, one or more noxel identifiers may be used an index to corresponding notarized ledgers. Other examples of space filling curves beyond Hilbert curves include, but are not limited to, Z-order curves, FASS curves, Peano curves, Morton curves, or other curves.

In use cases where context space 900 may not be partitioned in a highly regular fashion, additional techniques, possibly in combination with space filling curves, may be used to assign identifiers to the noxels. For example, the noxels may be defined based on a Voronoi technique (see URL en. wikipedia. org/wiki/Voronoi_diagram). In such a case, points in the context space may be identified first, then the shape of the noxels are determined based on the distance to the nearest neighboring points. Therefore, the shape of the noxels may be highly irregular, especially in higher dimensions. The index for the corresponding ledgers may be determined through various techniques. The irregular noxels index could simply be a hash of the noxels center point's set of attribute-value pairs for example. Alternatively or in addition to, the noxels irregular index may be assigned by a tree structure, possibly using a Vorornoi R-Tree (VR-Tree), Quad Tree, Voronoi Quad Tree (VQ-Tree), binary space partitioning (BSP, or other scheme. An additional technique may include use of a grid Voronoi (GridVoronoi) that provides for efficient spatial indexing as described in C. Zhang, G. Almpanidis, F. Hasibi and G. Fan, “Gridvoronoi: An Efficient Spatial Index for Nearest Neighbor Query Processing,” in IEEE Access, vol. 7, pp. 120997-121014, 2019, doi: 10.1109/ACCESS.2019.2937667. Alternatively, or in addition to, the noxel space may be partition based on a “vocabulary” where a single noxel identifier may represent a group of neighboring noxels. Vocabulary techniques that may be adapted for use with noxels are described in U.S. Pat. No. 10,796,196 to Bing et. Al. titled “Large Scale Image Recognition Using Global Signatures and Local Feature Information,” filed on March 7^{th}, 2016.

Such approaches are considered advantageous because they permit identifying target ledgers or layers of an application stack based on a reduced set of noxel identifiers, possibly spread over a large space in the context space thereby reducing the amount of data to be transmitted over a network while also providing accurate mapping to the target ledgers. See also the discussion below regarding use of image descriptors for context identifiers.

As discussed previously, providing indexing notarized ledgers schemes that leverage nearest neighbors enables numerous advantages. For example, when a device or user has a set of context characteristics (e.g., set of attribute-value pairs, etc.) that fail to fall within a noxel having a ledger, the context characteristics may still be near a noxel having a target ledger that still maybe “close enough.” The nearest neighbor ledger may be retrieved through a Knn search, especially when the ledgers are organized in a tree data structure possibly indexed by noxel identifiers. Example ledger organization data structures that may be used with the inventive subject matter may include directed acyclic graphs (DACs), Tries, trees, QV tree, VR tree, or other organizations. One should appreciate such structures are not required to be binary trees, but may have nodes with many branches. For example, each node of the data structure may have many child branches for each dimension of relevance for a specific context. Thus, a search path based on attributes (dimensions) through the data structure may end at an end leaf node for the correspondingly defined context. The end leaf node may then have a pointer to the target ledger. In such an organization, the path through the data structure can be considered the defined context. Pointers that may be used to point to the target ledger can include a URL, URI, GUID, UUID, Document Object Identifier (DOI), Healthcare Object Identifier (HOI), a storage location, a ledger node, a smart contract address or identifier, a network address (e.g., IPv4 or IPV6 address, TCP/UDP port number, MAC address, etc.), or other type of pointer.

Indexing schemes that permit nearest neighbor searches are useful, it is also contemplated that other forms of searches based on nearest neighbors can be used. For example, a distance or similarity vector may be calculated between a point in the context space representing a current context and a second point associated with an a priori defined context. Such distances or similarities may be calculated as a Euclidean distance, Manhattan distance, Minkowski distance, Chebyshev distance, cosine similarity or distance, Jaccard similarity, Mahalanobis distance, Hamming distance, or via other similarity metric techniques. If the similarity metric or distance metric satisfies the defined context's satisfaction criteria, then a pointer to the defined context's target ledger may be retrieved or otherwise returned to gain access to the target ledger. Thus, such metrics or satisfaction levels of the context's satisfaction criteria may be used to grant permission to access a ledger, access layers in a ledger-application stack, access a smart contract, control access levels to ledgers and/or their operations (e.g., read, write, observe, administer, create, delete, destroy, move, copy, manage smart contracts, manage layers, etc.), restrict access to a ledger, or otherwise authorize or manage access to the ledgers.

In view that one or more target ledgers can be accessed based on a context's satisfaction criteria, thereby generating one or more indices pointing to the target ledger or ledgers, one may access a target ledgers for various applications corresponding to the context (e.g., shopping ledger, gaming ledger, ATSes, etc.). FIG. 11 illustrates context-based ledger application stack ecosystem 1100 (ecosystem 1100 for short). Ecosystem 1100 may operate as part of or otherwise leverage system 100 from FIG. 1. Ecosystem 1100 illustrates how one or more of context 1120 associated with a device 1110 (e.g., cell phone, smart phone, vehicle, robot, appliance, desktop computer, set top box, gaming console, etc.) can be used to access one or more layers of an application stack to give rise to an application running on a notarized ledger. In the example shown, context 1120 may be considered active with respect to a user or device that satisfies the conditions required by context 1120.

Query 1125, likely transmitted over a network, can be constructed from one or more attributes and/or values of context 1120 as discussed previously. For example, query 1125 may include a single valued index referencing one or more ledgers from ledger lookup 1130. Alternatively or in addition to, query 1125 may include multiple values (e.g., context-based attribute-value pairs, names, features, matching criteria, etc.). A ledger having matching or satisfied criteria from the multiple values may be found by ledger lookup 1130. Ledger lookup 1130 may comprise a direct lookup table (e.g., indexed by location, indexed by hashes, indexed by name, indexed by GUIDs, etc.) through which a ledger or layer of a layer stack may be found, a database, a name service, SQL, or other type of lookup service able to map the features of context 1120 to one or more specific ledgers, or nodes through which a ledger may be accessed.

For the purposes of this discussion, ecosystem 1100 will be described in the context of an alternative trading system (ATS). In the example shown, context 1120 permits (or restricts) access to an ATS having two or more layers of a ledger-based application stack. For example, context 1120 may indicate that a user is located at a proper location, has a validated citizenship, is accessing the ATS at a proper time, or otherwise has satisfied other criterion or criteria to access the ATS, possibly based on Know Your Customer (KYC) and/or Anti-Money Laundering (AML) conditions. As illustrated ledger lookup 1130 provides access to multiple layers via layer pointer 1141 to a layer 1 level of the stack (ledger or ledgers 1151), pointer 1142 to at least one layer 2 level of the stack (integration layers 1152A through 1152N), and pointer 1143 to at least one layer 3 level of the stack (application layers 1153A through 1153N). One should appreciate that pointers 1141 through 1143 can operate as an index for their corresponding layers, possibly a smart contract address for example. While three layers are shown, any practical number of layers are contemplated. Application layers 1153A through 1153N may be implemented as a user facing application, a trading exchange application for an ATS for example (e.g., Coinbase: see URL www. coinbase. com; Robinhood see URL www. robinhood. com; Upstream Exchange: see URL www. upstream. exchange; etc.). One should appreciate that application layers 1153A through 1153N may represent other forms of applications capable of operating has part of the ledger-based application stack, possibly including mobile games, computer games, shopping, logistics, educational management, legal management, healthcare management, patient data management, real-world asset management (RWA), office management, human resource management, sales management, R&D management, resource or real-estate management, military applications, sports management, just to name a few.

Application layers 1153A through 1153N (collectively referred to as application layers 1153) may interface to one or more of integration layers 1152A through 1152N (collectively referred to as integration layers 1152). While ecosystem 1100 is illustrated as showing a many-to-many relationship among application layers 1153 and integration layers 1152, one should appreciate that a single application stack may also include one-to-one relationships as well as one-to-many relationships. For an ATS, application layer 1153A may represent a trading exchange application, which then links to integration layer 1152A representing a scaling layer to permit large numbers of transactions (e.g., thousands per second, millions per second, etc.) on notarized ledger 1151. Integration ledger 1152A may interface with ledger 1151 through various techniques including APIs, smart contracts, remote procedure calls, RESTful APIs, through share memories, or other techniques. Example notarized ledger infrastructure that may be adapted for use to create ledger-based application stacks includes software provided by the Arbitrum Foundation operating on the Ethereum blockchain (see URL arbitrum. foundation).

Additional layer 2 infrastructure that may be adapted for use may include Optimism, zkSynk, Base, Immutable X, and Linea. For security reasons, it may be preferable to leverage layer 2 infrastructure support Zero Knowledge (ZK) techniques, such as zkSynk.

While the example shown for ecosystem 1100 illustrates context 1120 triggering access to the application stack via layer pointers 1141 through 1143, it should be appreciated that more than one technique may be employed to obtain such pointers to support the application stack.

For example, context 1120 may provide access, upon satisfaction of any required authorization or authentication, to an application via layer 3 pointer 1142 pointing to one or more of application layers 1153A through 1153N. Application layer 1153A, for example, may have its own context, which provides access to layer 2 pointer 1142 from ledger lookup 1130, which provides access to integration layer 1152A. Continuing in the same vein, integration layer 1152A may also have a context through which it obtains pointer 1141 through which it is able to access layer 1 ledger 1151. Thus, each layer in an application layer stack may have its own context through which the complete stack may be built. In such cases, the application stack can be considered a dynamic data construct that may change over time as the various contexts change with time. As a practical example, consider a travel-based application. As a traveler moves from jurisdiction to jurisdiction, the travel application (layer 3) might not change because the context for the layer 3 application may not be sensitive to location. However, the corresponding integration layer's context may be updated based on the change of location to point to a layer 1 notarized ledger for the specific jurisdiction through which the traveler's transactions (e.g., photos, purchases, entrances, exits, etc.) may be recorded. Such techniques can advantageously provide dynamic shifting, possibly in real-time, of an application layer stack in a transparent fashion to the user or device endpoint.

FIG. 11 illustrates pointers 1141 through 1143 as individual indices through which corresponding layers in the application stack may be retrieved based on context 1120. Rather than obtaining the indices on an individual basis, it is possible to obtain them collectively. For example, context 1120 may leverage query 1125 to obtain a linked list, or other data structure, storing pointers 1141 through 1143. Thus, the indices for the various layers may be obtained as a single group associated with context 1120.

Additional exploration of context 1120 is warranted as it can take on a wide range of features. As discussed above, context 1120 can be considered to comprise a number of attributes, having specific values, possibly according to a well-defined namespace, ontology, or other organization. The context may be considered active, as previously stated, when a set of criteria are satisfied based on the attributes. Then, the context identifier may be used to retrieve one or more layer in the application stack. The context identifier may take on a wide variety of values. In some cases a single value may simply be an integer or index used to retrieve the ledger layer information from a direct lookup. Other single value indices may include a unique name, a UUID, GUID, a hash value (e.g., a hash of the attribute names and values, etc.), a DOI, a HOI, a URL, a URI, an address, a coordinate, or other single values. In yet more complex embodiments, the context identifier can be multi-valued having two or more values that in concert, possibly uniquely, identify the context. A multi-valued identifier can be considered a signature of the context. Such signature may include time stamps, multiple coordinates, or even object recognition descriptors (e.g., SIFT, HoGs, DAISY, SURF, etc.). For example, a building has an address that may be part of the context to activate that building's notarized ledger; however, when an object is recognized in relation to the building (e.g., parking space, product, logo, etc.), the context's full signature may become active. Thus, in some cases, one or more image descriptors may be used as an index to a target ledger. Yet additional attributes that may be part of a context's activation criteria or may be used, at least in part or derived from, as a ledger layer index may include fingerprint data, iris data, biometric data, facial pattern data, movement data, social security number, PIN, phone number, or other types of data derived from a user. Such an approach is considered advantageous for security reasons to ensure proper KYC or AML conditions are satisfied before permission or authorization is granted to access the target ledger. For embodiments where a large number (e.g., thousands, millions, etc.) of contexts may be present, target ledger layers may be organized according to a Trie, or other tree structure, where each node may branch according to the dimensions in the namespace. The nodes may be traversed based on the values of the contexts. When a terminal node is reach after having traversed valid branches having attribute values, the terminal node would point to the target ledger layer. If no node is found, then there is no target ledger layer. Still, such a structure provides for finding a nearest neighbor as well (Knn). Thus, use of descriptors, Tries, or other data structures permit finding a target ledger layer that is close or a “good enough” match as previously discussed.

The above discussion provides an overview indexing notarized ledgers and/or other layers of the ledger-based application stack. The following discussion expands on these concepts and provides additional considerations related to the disclosed techniques as well as contemplated applications and/or markets.

Application stacks may extend beyond providing utility with respect to ATSes. In view that an application stack is constructed of a set of layers processing a digital data flow from a user or device down to a ledger, indexed application stacks can also provide utility in other use cases where data flows in a similar manner. One example includes a workflow application stack where each stage in a workflow may correspond to a layer in the stack. Consider a patient sample processing workflow. Stages might include, just as an example, taking a sample, placing a sample on a slide, staining the sample, conducting histopathology on the sample, doing microdissection on the sample, sequencing the sample, diagnosing the sample, and storing the sample. Each stage's layer may be found by querying the ledger lookup system based on the appropriate defined context (e.g., healthcare facility ID, insurance information, patient identifier, etc.). The indices or pointers to the layer may then be used to access the layers and stitch them together to form the whole patient sample processing application stack. The layers may be stitched together via their corresponding APIs, for example. Example techniques that may be adapted for use in patient sample processing are described in U.S. Pat. No. 10,923,215 to Witchey et. Al. titled “Sample Tracking via Sample Tracking Chains, Systems and Methods,” filed on September 19^{th}, 2017. Other application stacks that can be managed via the ledger and/or layer based indexing include logistics, eSport game play, sports tracking, supply chain management, insurance claim adjudication, taxes, inventory management, shopping, healthcare management, manufacturing, security exchanges, real world assets exchanges, tokenized asset exchanges, construction or project management, just to name a few. Such data flow applications can also be constructed as a directed acyclic graphs (DAC) where the application stack can be considered a DAC through which the application may execute. Other examples of workflows that may benefit from the disclosed techniques include licensing workflows, legal workflows, educational workflows, logistic workflows, shipping workflows, shopping workflows, project workflows, maintenance workflows, or other types of workflows.

While the use cases of a context-based ledger application stack ecosystem are quite numerous and varied, there are quite a number of common features that may be deployed as desired across the use cases. In most cases each application stack processes transaction data, typically derived from some device data (e.g., user data, preferences, attributes, etc.), through the various layers to record one or more transactions on at least one target ledger 1151 (e.g., Ethereum, Solana, Wax, Cardano, Polkadot, XRP ledger, Hedera, etc.). Further, one or more layers of the application stack may employ or operate as a smart contract for the target ledger.

As discussed above, NFTs on one ledger may be used to represent an entirely different ledger. To expand on the utility of NFTs in ecosystem 1100, NFTs may be used in many other avenues. In some embodiments, an NFT's owner address may itself be an index (as discussed previously), but may also be a context identifier. Thus, the context itself may be considered the owner of the NFTs. In such cases, users may only access the utility of the NFT (e.g., smart contract interfaces, ledger transactions, APIs, RPCs, application features, etc.) when the users or devices satisfy the criteria of the context. Such an approach is considered advantageous in use cases where security is of import, say in a healthcare setting where healthcare providers process patient data or a military setting where secret information is processed.

One example use case relating to utility-based NFTs includes using an NFT to represent underlying infrastructure. For example, each layer in ecosystem 1100 may be represented by a corresponding NFT. Thus, a set of NFTs may represent the individual layers thereby creating the application stack when the NFTs'corresponding context's criteria are satisfied. When the contexts are satisfied, the corresponding smart contracts, NFTs or otherwise, may be invoked. Example NFT management techniques that may be adapted for use with context-based indexing are described in U.S. Pat. No. 11,880,824 to Witchey et. Al. titled “Managing Digital Blockchains via Digital Tokens, Systems, Methods, and Apparatus,” filed April 6^{th}, 2023. Once should appreciate that use of other types of digital tokens beyond NFTs are also contemplated. For example, a cryptocurrency (e.g., ERC-20 like currency token) token may only be accessed on a target when its context is satisfied. Such digital tokens may include stable coins, staked coins, composable tokens, collectible tokens, or other forms of tokens.

A more practical digital token example may be useful. Consider a scenario where the application stack in ecosystem 1100 forms a digital exchange system, possibly a system supporting tokenized securities. Such a system may have many regulatory requirements, briefly discussed above, possibly including jurisdictional requirements, geo-location requirements, citizenship requirements, biometric requirements (e.g., KYC criteria, etc.), multi-factor authentication, AML requirements, or other criteria or conditions. When a user or device has attributes or other features satisfying a context's criteria, the user or device may access the digital exchange system. The user may be permitted to engage the system by purchasing a cryptocurrency, a stablecoin for example, for the target ledger and then be permitted to conduct transactions with the system (e.g., purchasing, tokenizing, selling, transferring, etc.). Furthermore, the user may tokenize assets if desired. A real-world asset (RWA; e.g., stock, real-estate, art work, gaming collectibles, baseball cards, collateral, patents, copyrights, name, image, likeness, etc.) may be tokenized as one or more digital tokens. Custody of the RWA might be represented by a digital token, an NFT for example. Then, the user can tokenize the RWA by issuing a set of digital ownership tokens (e.g., a set of collectible tokens, ERC-20 tokens, etc.) representing ownership of the RWA and using the RWA as collateral. The individual digital ownership tokens can be then bought and sold individually. Thus, the ownership of the RWA may be fractionalized. In such a case, the set of digital ownership tokens may be capped at a specific number (e.g., 1,000 tokens; 1,000,000 tokens; etc.) as necessitated or desired by the market thereby allowing for creating scarcity with respect to the RWA. Still further, the ownership tokens may also include specific utility or functionality. Some of the ownership tokens may represent voting rights with respect to the disposition of the RWA, others might represent a priority on payout should the RWA be liquidated, or have other features.

In some embodiments the tokenized RWA or other securities may include a homogenous set of digital ownership tokens (e.g., all ERC 20 tokens, all NFTs, all collectible tokens, etc.) while in other embodiments the ownership tokens may be a heterogeneous mix of digital tokens, some ERC-20 tokens plus some collectible tokens plus some NFTs, and so on. Thus, the corresponding transactions may include a real-world asset transaction, a stock transaction, a real-estate transaction, stable coin transaction, a commodity transaction, a securities transaction, a license transaction, or other types of transactions.

While the above example focuses on a digital exchange system, the disclosed inventive techniques can also be applied to other areas where interactions among entities may be converted to transactions or otherwise tokenized. From a healthcare perspective, for example, a patient's data may be tokenized and when a patient shifts from one healthcare provider to another, the digital token representing the patient's data may shift from one provider to the other as the provider's and/or patient's context changes.

It is also contemplated that ecosystem 1100 may also be used in non-traditional arenas. By way of background, an entity may own a specific type of organism, possibly including a plant line, a cell line, a strain of yeast, or other type of organisms. For example, an owner of a plant might patent the plant. A cell line may also be patented and/or deposited in a cell depository (e.g., American Type Culture Collection (ATCC), European Collection of Authenticated Cell Cultures (ECACC), Deutsche Sammlung von Mikroorganismen und Zellkulturen (DSMZ), etc.). A yeast strain may be deposited in a bank (e.g., White Labs, Wyeast, Fermentis, etc.). In such cases, the ownership of the organisms may be tokenized. Further, other non-owners may gain access to the organism upon proper authorization (e.g., activating a context, etc.). Example organisms that may be used as a RWA include cell lines related to cancer or cancer research (e.g., NK92 cells, Hela cells, HEK293 cells, CHO cells, MCF-7 cells, Jurkat cells, etc.). An example NK92 cell line that may be used in such use cases include those described in U.S. 10,456,420 to Lee et. Al. titled “Genetically Modified NK-92 Cells and Monocolonal Antibodies for the Treatment of Cancer,” filed on March 25^{th}, 2016 (see also ATCC deposit CRL-2407). Such an approach provides for extending ownership rights beyond the terms of corresponding patents. Each transaction related to the organism may then be recorded on the corresponding target ledger. The target ledger may comprise a public ledger, a private ledger, a side chain, a layer 2 or layer 3 portion of the application stack, organism-specific ledger, or other part of the application stack. This approach can provide for tracking 3^{rd} party use of the cell and provides infrastructure for auditing such uses or identifying violation of cell owner rights.

Ecosystem 1120 presents an application stack having a single target ledger. However, it should be appreciated that an application stack may provide access to many different layer 1 notarized ledgers. The ledgers may leverage a single technological infrastructure (e.g., all Ethereum based, all Solana based, etc.) or may be a mix of ledger technological infrastructures; a mix of Ethereum, Solana, Hashgraph, or others for example. In either case, the disclosed approaches for indexing layers in the application stack may also be used to conduct transactions from one ledger to another where the upper layers of the stack (e.g., layer 2, layer 3, etc.) can comprise adapters that translate commands or other protocols of one ledger infrastructure to another.

For example, an NFT may be minted on Ethereum as a tokenized RWA. As the ownership tokens are bought and sold, a layer 2 adapter may be used to convert ownership tokens on Ethereum to another ledger, say Solana. This may be achieved by the layer 2 adapter coordinating the burning of the ownership tokens on Ethereum while minting new tokens on Solana. Further, each ledger may have corresponding NFTs that point to the tokenized RWA on the other ledger to retain common custody (or ownership if necessary) of the RWA. Thus, in some embodiments, an RWA may be tokenized as an NFT on a first ledger (say Ethereum) and then tokenized as a cryptocurrency on a second ledger (say Solana). Such cross ledger transactions may be managed via corresponding contexts. When each relevant context becomes active, the contexts'indices can be used to find the necessary adapter layer and the layer 1 target ledgers. This approach provides for a faster, a cheaper, and a transparent approach for cross ledger interactions when triggered by corresponding contexts. One example use of such cross ledger interactions may include a physical transfer of a tokenized RWA from one physical location to another, where each location may have its own application stack infrastructure or target ledgers. The RWA's tokens may be moved, as discussed previously, to the new location's ledger as needed. Another example use of cross ledger interactions includes interconnectivity among banks or other institutions, where the institutions are able to share data and communicate regarding asset transactions. Further, ecosystem 1100 provides for 24/7/365 access, upon authorization, as needed across institutions.

Ecosystem 1100 can provide a great deal of application stack adaptability due to its modular nature and ability to shift layers in and out as context 1120 changes, possibly in real-time and possibly within latency windows. Part of the adaptability arises from the functionality implemented at each layer of the application stack. Through the use of additional software, including smart contracts supporting corresponding target ledgers and/or digital token, the layers are highly programmable and able to dynamically execute instructions, possibly based on one or more triggering conditions. Such triggering conditions may include the nature of context 1120 (e.g., attributes, values, changes, etc.). For example, as alluded to above, should context 1120 change, a layer may be swapped out. However, in some embodiments, the definition of context 1120 may be quite complex and include a broad range of attribute values that would be considered acceptable for context 1120 to remain validly active. As the values of the dimensions of relevance change within the definition of context 1120, a corresponding layer may take action. Consider a scenario where context 1120 depends one location or time. As the features or attributes of context 1120 changes and approaches one of its boundaries, a corresponding layer, say layer 2, may initiate a provisioning of a new layer 2 on device 1110 in preparation for a hand over. Alternatively, the layer may remain in place; however, the transactions it initiates or otherwise manages may shift from one account, possibly a home-related finance account, to a second different account, say a work-related finance account. Thus, these techniques provide for highly dynamic programmability able to trigger events such as following schedules (e.g., patient treatment, paying bills, etc.), taking actions based on target balances, taking actions based on time and/or location, execute just-in-time funding for transactions, provisioning device 1110 or network infrastructure, or otherwise managing transactions within the application stack or on one or more target ledgers.

Ecosystem 1100 is a computing platform on which application stacks execute. As such, the platform requires corresponding hardware and software (see discussion in regards to FIG. 8). Still, the computing platform executing ledger-based application stacks may be optimized to increase performance and/or efficiency. One issue with ledger-based systems is the storage of ledger data. In typical existing systems (e.g., Ethereum, Solana, Dogecoin, etc.), each node participating in the ledger must store the entire ledger. Typically, this approach is considered a feature because it mitigates the risk of bad actors making changes to the ledger as a whole. However, it is still an inefficient use of memory. A better approach for storing public ledger data includes only storing some of the ledger data at each node, most recent blocks for example. Further, the complete ledger may be stored by distributing only portions of the ledger across nodes, or other off-ledger storage devices, in a manner where the completed ledger may be reconstructed as necessary from the storage locations.

One approach for storing large amounts of data across nodes that may be adapted for use includes the CEPH distributed storage system (see URL www.ceph.io/en/). In some embodiments, the target ledger data may be stored in nodes where the nodes also operate as members of one or more CEPH clusters. Further, the target ledger data, or other application layer data, or blocks may be distributed across the storage devices using erasure coding where the data is split into fragments. Nodes in the system may only store some of the fragments, but not all. The data may be reconstructed even if some data is lost. Such an approach is considered advantageous for the disclosed techniques because the fragments, blocks, portions, or other pieces of the ledger data may be stored in accordance with requirements of a corresponding context's definition. For example, if an application stack may only be accessed at specific locations, then the target ledger may only be stored at such locations, or possibly far from the specified locations for security or redundancy reasons. Example techniques that may be adapted for use in storing ledger-based application stack includes those described in U.S. Pat. No. 11,662,938 to Bassett titled “Object Storage and Access Management Systems and Methods,” filed May 10^{th}, 2021.

In yet other embodiments, the ledger-based application storage stack may store data using a torrent protocol. In a torrent protocol, each block of data has a hash value. Each node also has an identifier in the same hash space. Blocks are duplicated among neighboring nodes having identifiers that are closest or most similar to a block's hash value. The number of duplications can be a priori defined (e.g., five duplications, 10 duplications, 100 duplications, etc.) as desired for the application. The ledger data may then be reconstructed through requesting blocks having the known hash values from the nearest neighbors having identifiers closest to the blocks hash values. If a queried node does not have the block, it will forward the request to its neighbors having hash identifiers closest to the blocks hash values, and so on. The use of torrents for blockchain storage were first suggested by one of the inventors in U.S. Pat. No. 11,386,985 to Witchey titled “Healthcare Transaction Validation via Blockchains, Systems and Method,” filed on May 13^{th}, 2019. These approaches provide for more efficient storage of ledger-based application stack data, especially for ledger data. Data may be transported or stored using various formats according to the target ledger's protocols. Example formats or systems that may be used include XML, YML, CAML, JSON, compressed data, binary data, binary large object (BLOB), IPFS, Arweave, Filecoin, Storj, Sia, Merkle trees, or other formats. A relatively new data type system includes Token-Oriented Object Notation (TOON) that lends itself to a more compact text-based data type system than JSON. TOON may be especially suited to AI systems leveraging the ledger-based application stack for LLMs, LRMs, or another AI-based system.

May of the use cases for ledger-based application stack require various forms of security to protect the data. For example, in USA healthcare settings patient data must be secured to comply with the Health Insurance Portability and Accountability Act (HIPAA) so that patient data is kept private. In view that many notarized ledgers operate in a public fashion, there is a need to ensure ledger-based application stacks operate or store data in a secure fashion. In some embodiments, the layers of an application stack may create secured memory spaces where data passing to, from, or through the layer is encrypted. For example, one or more layers may instantiate a homomorphic encryption space where data is encrypted and in which the layers may operate on the encrypted data without exposing the data. Thus, the disclosed techniques provide for using contexts to index or retrieve homomorphic spaces in a ledger-based application stack. The homomorphic encrypted spaces may be instantiated in the memory of a ledger node or on an off ledger device. Example techniques that may be adapted for use by the layers to create homomorphic encrypted spaces includes those described in U.S. Pat. No. 9,819,650 to Soon-Shiong et. Al. titled “Homomorphic Encryption in a Healthcare Network Environment, System and Methods,” filed on July 21^{st}, 2015. Thus, one aspect of the inventive subject matter is considered to include conducting ledger-based transactions, including digital token transactions, withing homomorphic encryption spaces. Further, a context's index may also include a pointer or index to such homomorphic encryption spaces or homomorphic encryption ledge layers.

From a different security perspective, time to time a user or other entity may lose access to their ledger account information, possibly their wallet address, owner address, token identifiers, or other information that may permit the user to conduct transactions based on context. In some embodiments, the user may use KYC information to establish a secret context through which the system may authenticate or validate the user. For example, the user might have a context defined that requires the user scan their biometric information (e.g., finger print, iris, face, genomic sequences, etc.) while at a specific location and in view of an authorized entity (e.g., bank manager, inspector, etc.). When the context is activated, the context's index may be revealed (e.g., decrypted, etc.) to the user. In such cases, the context's index could be the lost wallet's address, token identifier, or other information. Such approaches are considered advantageous for institutions deploying the disclosed inventive techniques to support ecosystem 1100. Example institutions may include brokers, banks, real-estate agents, county recorders, doctors, healthcare providers, governments, employers, military, or other institutions.

Ecosystem 1100 provides support for a vast number of possible use cases. In some embodiments, the ledger-based application stack may be used to support various machine learning platforms including those supporting Large Language Models, Large Reasoning Models, trained machine learning models, or other types of machine learning systems. More specifically, transactions in the system may relate to tracking underlying machine learning training data, which may be useful to authenticate or validate how the machine learning system was trained. For example, a digital token can be minted that represents a machine learning training data set or a machine learning trained model (e.g., LLM, LRM, reasoning engines, etc.). Still further, when a user or device satisfies a defined machine learning context (e.g. location, time, KYC information, etc.), the user or device may then access the machine learning application stack. Consider a scenario where a machine learning application stack operates in a healthcare setting. The upper layer of the stack can include a trained model able to provide diagnosis or prognosis based on user input or patient data. As a healthcare provider interacts with the upper layer models, the lower layers may record transactions of the provider's interactions related to the upper layer models on the target layer 1 ledger. Such an approach aids in tracking interactions for insurance purposes or for later audits. Examples of models that may be adapted for using with ledger-based AI or reasoning system application stacks includes those described in U.S. Pat. No. 9,262,719 to Soon-Shiong titled “Reasoning Engines,” filed January 3^{rd}, 2012.

Yet another use case include digital content management, possibly content related to augmented reality, virtual reality, mixed reality, gaming, or other types of digital content. On one hand, as content is being created, a ledger-based application stack may be used to record transactions related to the created content. For example, digital tokens may be minted and recorded to represent the content and reflect the actual ownership of the content. This approach provides for determining or validating provenance of the content. Still further, the content may be bound to a context. When a user or device satisfies the context's requirements, they may then access features associated with the content via the corresponding ledger-based application stack. In a gaming environment, the user may be permitted to purchase in game objects (e.g., functionality, weapons, armor, collectibles, characters, NPCs, virtual real-estate, etc.).

Additionally, a context may require that a digital representation of a scene or environment around device 1110, possibly a multi-modal digital representation, satisfy recognition requirements. The digital representation may be captured via one or more sensors (e.g., camera, microphone, thermometer, GPS unit, magnetometer, Hall probe, piezoelectric sensor, RFID reader, NFC reader, radio, LiDAR, RADAR, infrared sensor, barometer, accelerometer, etc.). One or more implementations of recognition algorithms may operate on the digital representation to identify features (e.g., descriptors, audio signals, wave forms, etc.) within the representation. When the features satisfy or match one or more criterion in the context's definition, the context may activate providing access to the corresponding application stack. For example, image features can be used to anchor augmented reality content that is superimposed on a real-world image or video rendered on a display screen.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A computer-based data indexing system comprising:
at least one non-transitory computer readable memory storing a plurality of notarized ledgers where each notarized ledger is indexed by at least one corresponding context index and storing software instructions; and
at least one processor coupled with the at least one memory, upon execution of the software instructions, performs the following operations:
obtaining digital transaction data including digital transaction context information associated with at least one real-world device;
generating a transaction context index as a function of the digital transaction context information;
accessing an indexed notarized ledger stored in the at least one memory from the plurality of notarized ledgers where the context index corresponding to the indexed notarized ledger satisfies a query based at least in part on the transaction context index;
instantiating a transaction record memorializing the digital transaction data with respect to the real-world device;
instantiating a ledger transaction from the transaction record and adhering to a format of the indexed notarized ledger; and
recording the ledger transaction representing the transaction record on the indexed notarized ledger in the at least one memory.

2. The computer-based data indexing system of claim 1, wherein the at least one memory comprises one or more of the following: a storage area network (SAN), a network area storage (NAS) system, a distributed storage system, a cloud-base storage system, a file system, a distributed file system, or a torrent.

3. The computer-based data indexing system of claim 1, wherein the plurality of notarized ledgers includes one or more of the following types of ledgers: a blockchain, a hashgraph, a directed acyclic graph, a holochain, or a distributed ledger.

4. The computer-based data indexing system of claim 1, wherein the transaction context index comprises a hash value.

5. The computer-based data indexing system of claim 4, wherein the hash value is calculated based, at least in part, on the digital transaction context information.

6. The computer-based data indexing system of claim 1, wherein the digital transaction context information adheres to at least one of a namespace or a ontology.

7. The computer-based data indexing system of claim 1, wherein the transaction context index comprises a single value derived from the digital transaction context information.

8. The computer-based data indexing system of claim 7, wherein the single value is derived according to a space filling curve.

9. The computer-based data indexing system of claim 1, wherein the transaction context index comprises a multi-value index.

10. The computer-based data indexing system of claim 1, wherein the digital transaction context information comprises at least two dimensions of relevance.

11. The computer-based data indexing system of claim 9, wherein the digital transaction context information comprises at least three dimensions of relevance.

12. The computer-based data indexing system of claim 1, wherein the ledger transaction comprises a digital token transaction associated with at least one digital token.

13. The computer-based data indexing system of claim 12, wherein the digital token comprises a currency token.

14. The computer-based data indexing system of claim 12, wherein the digital token comprises a non-fungible token.

15. The computer-based data indexing system of claim 12, wherein the digital token comprise a tokenized asset.

16. The computer-based data indexing system of claim 1, wherein the ledger transaction comprises an exchange transaction.

17. The computer-based data indexing system of claim 16, wherein the exchange transaction comprises at least one of the following: a real-world asset transaction, a stock transaction, a real-estate transaction, stable coin transaction, a commodity transaction, a securities transaction, or a license transaction.

18. The computer-based data indexing system of claim 1, wherein the indexed notarized ledger comprises a layer two ledger.

19. The computer-based data indexing system of claim 18, wherein the ledger transaction comprises a layer two transaction recorded on the indexed notarized ledger.

20. The computer-based data indexing system of claim 1, wherein the ledger transaction comprises a smart contract transaction.
